(19) United States
(12) Patent Application Publication
(10) Pub. No.: US 2023/0204541 A1
(43) Pub. Date: Jun. 29, 2023

(54) DETECTION CELL, FAIMS DEVICE, AND PROGRAM

(71) Applicant: Sharp Display Technology Corporation, Kameyama City (JP)

(72) Inventors: Tomohiro KOSAKA, Kameyama City (JP); Tomoko TERANISHI, Kameyama City (JP); Kei IKUTA, Kameyama City (JP); Yuuki OOTSUKA, Kameyama City (JP); Reshan Maduka ABEYSINGHE, Kameyama City (JP)

(21) Appl. No.: 18/087,269

(22) Filed: Dec. 22, 2022

(30) Foreign Application Priority Data
Dec. 24, 2021 (JP) 2021-210060

(51) Int. Cl. G01N 27/624

(52) U.S. Cl. CPC G01N 27/624

(57) ABSTRACT

A detection cell includes a pair of filter electrodes, disposed separated from and opposing each other. One of the pair of filter electrodes includes a first region provided following a flow direction of an object of measurement introduced between the filter electrodes, and a second region that is provided arrayed with the first region regrading an intersecting direction intersecting the flow direction, and that protrudes to a position at which a distance of separation as to another of the pair of filter electrodes is smaller than that of the first region. First and second downstream-side electrodes are respectively disposed on downstream sides of the first and second regions, in the flow direction, and are separated from each other regarding the intersecting direction. First and second opposing electrodes are disposed on the downstream side from the other of the pair of filter electrodes, and oppose the first and second downstream-side electrodes.

### BACKGROUND

### 1. Field

The present disclosure relates to a detection cell, a FAIMS device, and a program.

### 2. Description of the Related Art

Conventionally, an analysis method in which an analyte that contains a plurality of components is ionized and made to flow, during which components are separated and detected, is in widespread use. For example, Japanese Patent No. 5,015,395 discloses a field asymmetric ion mobility spectrometry (FAIMS) system, in which a plurality of detection cells including a pair of filter electrodes and a pair of detection electrodes are arrayed along a channel. According to the configuration in Japanese Patent No. 5,015,395, conditions for separating ions can be optionally changed for each detection cell, and different types of ions can be detected at the same time.

However, the above configuration results in an increase in the number of filter electrodes, and moreover, voltage applied to each electrode has to be respectively controlled. Accordingly, there is a problem in that control of voltage applied to each detection cell, and the circuit configuration for this control (e.g., see FIG. 7), become large-scale and complicated. Excessive thinning of wiring and multi-layer structures in FAIMS devices is problematic with respect to the point that trouble such as short-circuiting, line breakage, and so forth readily occurs due to application of high voltage for forming a filter electric field.

It is desirable to improve FAIMS devices (e.g., realization of both simplification of configuration and reduction in analyzing time and so forth).

### SUMMARY

According to an aspect of the disclosure, a detection cell includes a pair of filter electrodes, a first downstream-side electrode, a second downstream-side electrode, a first opposing electrode, and a second opposing electrode. The filter electrodes are disposed separated from each other and opposing each other. One of the pair of filter electrodes includes a first region that is provided following a flow direction of an object of measurement introduced between the pair of filter electrodes, and a second region that is provided arrayed with the first region with respect to an intersecting direction intersecting the flow direction, and that protrudes to a position at which a distance of separation as to an other of the pair of filter electrodes is smaller than that of the first region. The first downstream-side electrode and the second downstream-side electrode are respectively disposed on a downstream side of the first region and the second region, in the flow direction, and are separated from each other with respect to the intersecting direction. The first opposing electrode and the second opposing electrode are disposed on the downstream side from the other of the pair of filter electrodes, and oppose the first downstream-side electrode and the second downstream-side electrode.

According to another aspect of the disclosure, a FAIMS device includes the above detection cell, and a first control unit that controls at least distributed voltage applied across the pair of filter electrodes.

According to another aspect of the disclosure, a program includes instructions of applying, by the first control unit, asymmetric alternating current voltage of a first magnitude across the pair of filter electrodes, and applying, by the second control unit, direct current voltage across the pair of filter electrodes while changing a magnitude thereof, during application of the asymmetric alternating current voltage of the first magnitude across the pair of filter electrodes. The program is for operating the above FAIMS device. The magnitude of the direct current voltage applied by the second control unit is changed within a range in which a magnitude of an electric field formed in the first region by the asymmetric alternating current voltage of the first magnitude, and a magnitude of an electric field formed in the second region, are not duplicative.

According to another aspect of the disclosure, a program includes instructions of applying, by the first control unit, asymmetric alternating current voltage of a first magnitude and a second magnitude across the pair of filter electrodes, and applying, by the second control unit, direct current voltage across the pair of filter electrodes while changing a magnitude thereof, during application of the asymmetric alternating current voltage of the first magnitude or the second magnitude across the pair of filter electrode. The program is for operating the above FAIMS device. The magnitude of the direct current voltage applied by the second control unit is changed within a range in which a magnitude of an electric field formed in the first region by the asymmetric alternating current voltage of the first magnitude and the second magnitude, and a magnitude of an electric field formed in the second region, are not duplicative.

### BRIEF DESCRIPTION OF THE DRAWINGS

FIG. 1 is a schematic diagram illustrating mobility analysis by a FAIMS device including a detection cell according to an embodiment;

FIG. 2 is a schematic diagram corresponding to a cross-section taken along line A-A in FIG. 1;

FIG. 3 is a partial plan view of a first substrate having differently-shaped electrodes;

FIG. 4 is a block diagram of a control device in the FAIMS device according to the embodiment;

FIG. 5 is a partially-enlarged diagram of a FAIMS spectrum obtained by the FAIMS device according to the embodiment;

FIG. 6A is a diagram describing acquisition conditions of a FAIMS spectrum according to the related art;

FIG. 6B is a diagram describing acquisition conditions of a FAIMS spectrum according to the present technology;

FIG. 7 is a partial plane view of a substrate having conventional electrodes;

FIG. 8A is cross-sectional views illustrating part of a manufacturing process of the detection cell according to the embodiment;

FIG. 8B is cross-sectional views illustrating another part of the manufacturing process of the detection cell according to the embodiment;

FIG. 8C is cross-sectional views illustrating another part of the manufacturing process of the detection cell according to the embodiment;

FIG. 9A is cross-sectional views illustrating part of a manufacturing process of the detection cell according to another embodiment;

FIG. 9B is cross-sectional views illustrating another part of the manufacturing process of the detection cell according to another embodiment;

FIG. 9C is cross-sectional views illustrating another part of the manufacturing process of the detection cell according to another embodiment;

FIG. 10A is cross-sectional views illustrating part of the manufacturing process of the detection cell according to another embodiment;

FIG. 10B is cross-sectional views illustrating another part of the manufacturing process of the detection cell according to another embodiment;

FIG. 11A is a plan view illustrating a manufacturing process of the detection cell according to the embodiment;

FIG. 11B is a plan view illustrating a manufacturing process of the detection cell according to the embodiment;

FIG. 11C is a plan view illustrating a manufacturing process of the detection cell according to the embodiment;

FIG. 11D is a plan view illustrating a manufacturing process of the detection cell according to the embodiment;

FIG. 12 is a cross-sectional view of a FAIMS device according to another embodiment;

FIG. 13 is a cross-sectional view of a FAIMS device according to another embodiment;

FIG. 14 is a cross-sectional view of a FAIMS device according to another embodiment; and

FIG. 15 is a cross-sectional view of a FAIMS device according to another embodiment.

### DESCRIPTION OF THE EMBODIMENTS

A desirable embodiment of the technology disclosed herein will be described below. Matters other than matters mentioned in particular in the present specification (e.g., a structure of a detection cell disclosed herein), which are necessary for carrying out the present technology (e.g., a configuration of an ionization source and driving technology thereof, general matters regarding conditions for generating a drift electric field and so forth, and general matters relating to processing and analysis of detection information from the detection cell), can be understood to be design choice made by one skilled in the art on the basis of the related art in the field of analytical engineering. The present technology can be carried out on the basis of the contents disclosed in the present specification and common general technical knowledge in this field.

### Embodiment 1

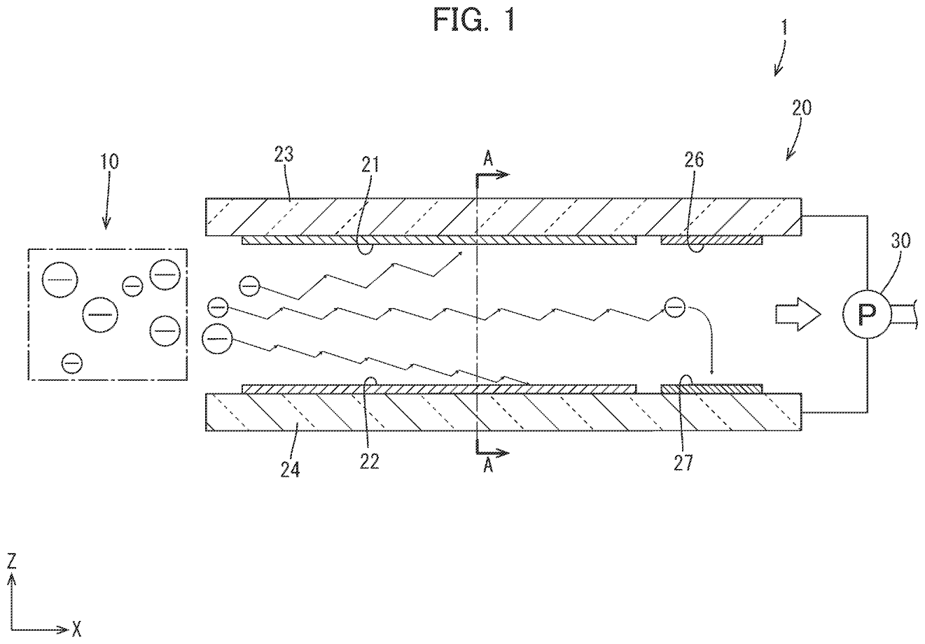

First, features of the detection cell disclosed herein will be described with reference to FIGS. 1 to 11D as appropriate. FIG. 1 is a diagram illustrating a general configuration of a field asymmetric ion mobility spectrometry (FAIMS) device 1 using a detection cell 20 according to the present embodiment (hereinafter may be referred to simply as “analyzing device”). The analyzing device 1 includes an ionization source 10, the detection cell 20, a pump 30 (an example of a blower device), and a control device 40. Description will be made below regarding the components. The X, Y, and Z in the drawings respectively indicate a direction of flow of an object of measurement, an intersecting direction, and an electric field direction. Note however, that these directions have only been set for the sake of convenience, and are not to be interpreted restrictively.

The ionization source 10 is a device that ionizes atoms and molecules in a compound that is the object of measurement. The object of measurement changes into a configuration that is detectable at the detection cell 20 by being ionized by the ionization source 10. The ionizing technique of the ionization source 10 is not limited in particular, and various types of conventional ionization sources can be used. Specific examples of the ionizing technique include electron impact (EI) ionization, chemical ionization, gas-discharge ionization, photoionization, desorption ionization, electrospray ionization (ESI), thermal ionization, ambient ionization, and so forth, combinations thereof, and so forth. An ionization source by which components to be detected can be ionized may be selected as appropriate. A needle electrode is provided as the ionization source 10 in this example, although not illustrated in detail, reactant ions are generated by corona discharge at this needle electrode under atmospheric pressure, which are caused to react with specimen atoms or specimen molecules, thereby indirectly generating specimen ions (charged particles). Specimen ions are not limited to ions of the object of measurement, and may be reactant ions, ion clusters, or the like.

Besides the above-described needle electrode, the ionization source 10 may be an ionizing unit that includes a radioactive ion source such as a nickel isotope (63Ni), americium isotype (241Am), or the like, and ionizes the specimen generated from the radioactive ion source, an ionizing unit that includes a includes an ultraviolet pulse laser oscillator and directly ablating and ionizing the specimen by irradiation with ultraviolet pulsed laser light, or the like. The specimen ions generated by the ionization source 10 ride an airflow generated by an atmospheric gas (a neutral buffer gas) such as atmospheric air, carrier gas, or the like, being blown by the later-described pump 30, and are carried toward the detection cell 20.

The pump 30 is a component for mobilizing the atmospheric gas containing the specimen ions along the direction of flow through the detection cell 20. The pump 30 according to the present embodiment is disposed on a downstream side of the detection cell 20 with respect to the direction of flow. Various types of blower devices that can blow specimen ions generated by the ionization source 10 to the detection cell 20, which will be described later, at a predetermined speed can be used as the pump 30. The blowing mechanism of the pump 30 is not limited in particular, and may be a diaphragm type, a rotary wing type, a piston type, a rotary vane type, or other blower devices and so forth. As one example, a micro-blower of which the maximum discharge pressure is no more than around 0.03 MPa, and the airflow is no more than around 1 L/min can be used as the pump 30, although this depends on the size and so forth of the detection cell 20. For example, a micro-blower that causes fluctuation of a diaphragm by high-frequency oscillation (e.g., ultrasonic oscillation) by a piezoelectric ceramic works suitably as the pump 30 used in the present embodiment, with respect to the point that blowing can be performed with suppressed pulsation.

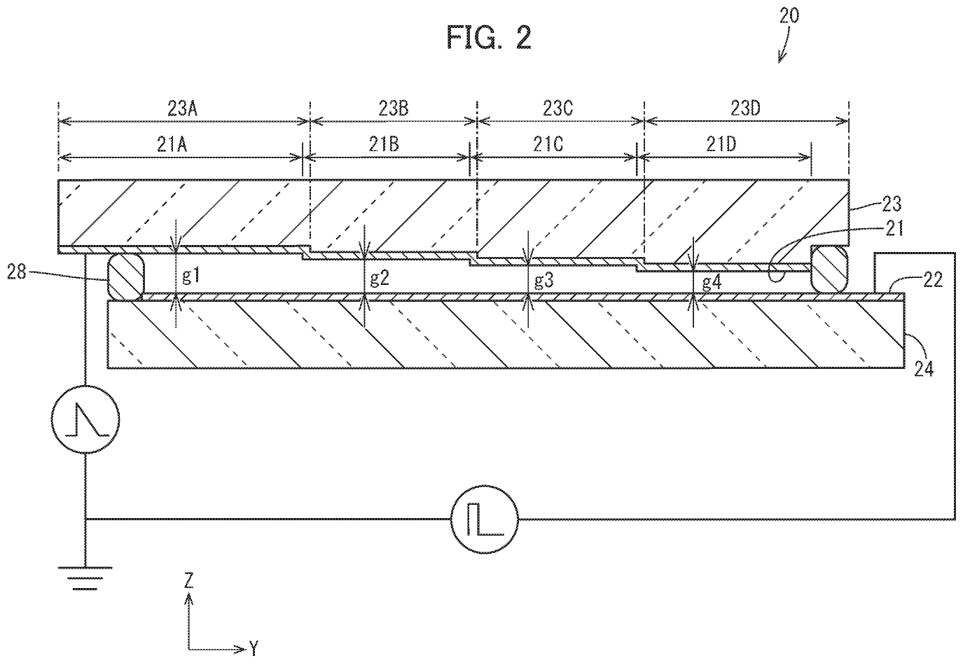

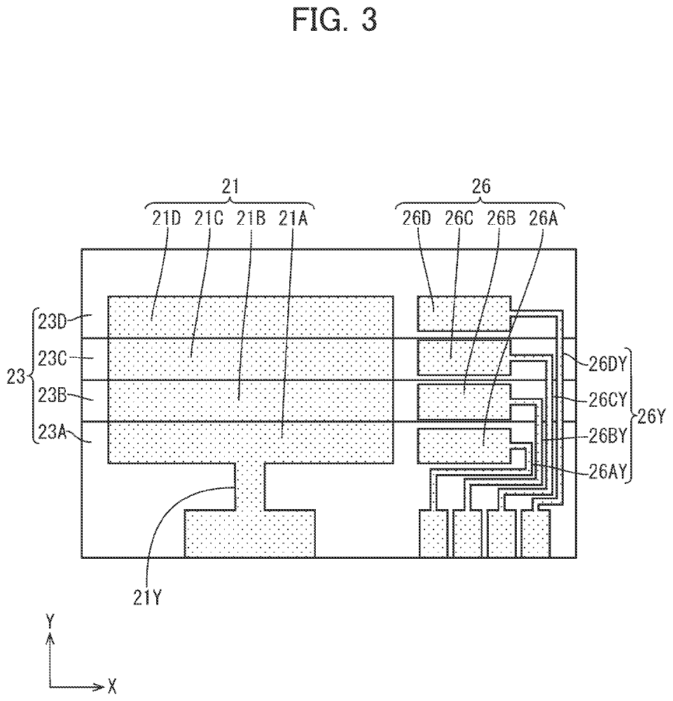

The detection cell 20 is a component that separates (filters) ions generated by the ionization source 10 on the basis of difference in mobility, and detects each ion of a predetermined mobility. The detection cell 20 may include a first substrate 23 (an example of a first base member) and a second substrate 24 (an example of a second base member), which serve as a pair of base members in the present technology, and electrodes supported by this pair of base members, as illustrated in FIGS. 2 and 3. The electrodes may include a differently-shaped electrode 21 (an example of one filter electrode), a planar electrode 22 (an example of another filter electrode), a deflection electrode 26, and a detection electrode 27. These components of the detection cell 20 may be disposed within a chamber that is omitted from illustration.

The differently-shaped electrode 21 and the planar electrode 22 make up of a pair of filter electrodes in FAIMS analysis, by being disposed separated from each other and opposing each other. The flow of specimen ions is introduced between the differently-shaped electrode 21 and the planar electrode 22. Hereinafter, the direction in which the specimen ions flow between the differently-shaped electrode 21 and the planar electrode 22 will be referred to as “flow direction”. Between the differently-shaped electrode 21 and the planar electrode 22 is ion separation space (draft space). The differently-shaped electrode 21 and the planar electrode 22 according to this example are provided on the opposing faces of the first substrate 23 and the second substrate 24 which will be described later (the same as supporting faces thereof), respectively. Generally, a pair of filter electrodes are so-called parallel plate electrodes, of which the opposing faces of the pair of electrodes are flat. A configuration that is the same as a conventional electrode can be employed for the planar electrode 22. The normal direction of the planar electrode 22 generally agrees with the direction of the electric field formed between the pair of filter electrodes. In contrast with this, the surface of the differently-shaped electrode 21 according to the present technology, which faces the planar electrode 22, is not flat, and has step-like formations.

The shapes, sizes, and so forth, of the differently-shaped electrode 21 and the planar electrode 22 are not strictly limited. The differently-shaped electrode 21 and the planar electrode 22 typically have generally the same shape in plan view. Also, the differently-shaped electrode 21 and the planar electrode 22 according to the present embodiment each have rectangular shapes that are long in the flow direction, in plan view. The dimensions of the differently-shaped electrode 21 and the planar electrode 22 along the flow direction of specimen ions are, for example, no less than around 0.1 cm (e.g., no less than around 1 cm), and no more than around 50 cm (e.g., no more than around 10 cm), although not limited to this. The thicknesses of the differently-shaped electrode 21 and the planar electrode 22 are not limited in particular, and each may be independently set as appropriate within a range of no less than around 50 nm and no more than around 1 μm, for example. The thicknesses of the differently-shaped electrode 21 and the planar electrode 22 typically are no more than around 600 nm, such as no more than around 400 nm for example, and typically may be no less than around 100 nm, such as no less than around 200 nm, for example. Hereinafter, when differentiation between the differently-shaped electrode 21 and the planar electrode 22 does not have to be made, these may be collectively referred to as “filter electrodes 21 and 22”.

In further detail, the differently-shaped electrode 21 includes a plurality of regions provided longitudinally along the flow direction of the object of measurement in the detection cell 20. These regions are a first region 21A, a second region 21B, a third region 21C, and a fourth region 21D. The first region 21A, second region 21B, third region 21C, and fourth region 21D are disposed arrayed together with respect to the intersecting direction in plan view (as viewed in the electric field direction). These four regions are arrayed in the order of first region 21A, second region 21B, third region 21C, and fourth region 21D, in plan view, in the present embodiment. These four regions may have shapes in which the second region 21B protrudes more toward the planar electrode 22 with respect to the first region 21A, the third region 21C with respect to the second region 21B, and the fourth region 21D with respect to the third region 21C, such that the distances of separation as to the planar electrode 22 become smaller in this order. The regions are connected therebetween by connecting portions, and the differently-shaped electrode 21 is configured of a single electrode as a whole.

Distances of separation between the filter electrodes 21 and 22 have the relation

g1>g2>g3>g4

where the distance of separation between the first region 21A and the planar electrode 22 is a first gap g1, between the second region 21B and the planar electrode 22 is a second gap g2, between the third region 21C and the planar electrode 22 is a third gap g3, and between the fourth region 21D and the planar electrode 22 is a fourth gap g4. Also, when a filter voltage Vf is applied across these filter electrodes 21 and 22, electric fields formed therebetween have the relation

E1=Vf/g1

E2=Vf/g2

E3=Vf/g3

E4=Vf/g4

E1<E2<E3<E4

where an electric field formed between the first region 21A and the planar electrode 22 is a first electric field E1, an electric field formed between the second region 21B and the planar electrode 22 is a second electric field E2, an electric field formed between the third region 21C and the planar electrode 22 is a third electric field E3, and an electric field formed between the fourth region 21D and the planar electrode 22 is a fourth electric field E4.

That is to say, when n (where n is a natural number of two or greater, typically n=2 to 50, exemplarily 4 to 5) regions are provided to the differently-shaped electrode 21, and the dimension between each region and the planar electrode 22 is gn, the magnitude of the electric field En formed by applying the filter voltage Vf across the differently-shaped electrode 21 and the planar electrode 22 in these regions can be expressed by Vf/gn. Accordingly, the magnitude of the electric field En formed is different for each of the regions. Note that the filter voltage Vf is the sum of dispersion voltage (DV, also referred to as asymmetric radio-frequency voltage) and compensation voltage (CV). Note that in the present embodiment, the differently-shaped electrode 21 and the planar electrode 22 are respectively connected to a first potential adjusting unit 41 and a second potential adjusting unit 42 of the control device 40 that will be described later, and the distributed voltage DV and the compensation voltage CV are applied by the first potential adjusting unit 41 and the second potential adjusting unit 42.

The distance of separation between the filter electrodes 21 and 22 (e.g., g1) is not strictly limited. Setting the distance of separation so as to be narrow is desirable, since doing so effectively increases the intensity of the electric field (e.g., E1) formed in the ion separation space. Now, an arrangement in which the flow of specimen ions between the filter electrodes 21 and 22 forms a laminar flow following surfaces of the filter electrodes 21 and 22 is desirable, since the specimen ions can be efficiently transported. However, a distance of separation that is too narrow leads to a contradiction in that turbulence readily occurs in the discharge and flow of specimen ions between the differently-shaped electrode 21 and the planar electrode 22. Accordingly, the distances of separation (e.g., g1 to g4) can each be independently set to, for example, no less than around 30 μm (typically no less than 50 μm), and in one example no more than around 1 mm, for example, no more than around 500 μm (typically no more than around 300 μm).

The distances of separation g1 to g4 of the respective regions 21A to 21D of the differently-shaped electrode 21 may be set such that the difference in the electric fields E1 to E4 formed between the regions 21A to 21D and the planar electrode 22 (e.g., electric field gap ΔE) is equal regarding the two regions of which the distances of separation are similar, as far as possible, although this is not limiting. As one example, in a combination of the first region 21A and the second region 21B of which the distances of separation are similar, when a difference in electric field is ΔE₁₂ (i.e., E2 minus E1), the distances of separation g1 to g4 of each of the regions are desirably set such that, in other combinations of two regions of which the distances of separation are similar, i.e., the second region 21B and the third region 21C, and the third region 21C and the fourth region 21D, the differences in electric field ΔE₂₃ (i.e., E3 minus E2) and ΔE₃₄ (i.e., E4 minus E3) are generally equal to ΔE₁₂. While the following figures are not intended to be taken as a rule, since the dimensions between two adjacent regions (gap ΔG) depend on the distance of separation g, the filter voltage Vf, and so forth in the present embodiment, an exemplary arrangement can be given in which the dimensions are no less than around 0.1 μm (typically no less than around 0.5 μm, no less than around 1 μm), and are, for example, no more than around 100 μm (typically no more than around 50 μm, no more than around 10 μm).

The material making up the filter electrodes 21 and 22 is not limited in particular. It is sufficient for the material making up the filter electrodes 21 and 22 to be any of various types of electroconductive materials that are capable of generating a later-described electric field between the electrodes, and may be any of a metal material, an inorganic electroconductive material, and an organic electroconductive material. In a case in which the specimen that is an analyte and ions thereof conceivably will exhibit metal corrosivity, employing any one of an inorganic electroconductive material and an organic electroconductive material as the electroconductive material making up the surface of the filter electrodes 21 and 22 is desirable. Metal material making up the filter electrodes 21 and 22 is not limited in particular, and in a case of fabricating the filter electrodes 21 and 22 by lithography technology using an argon fluoride (ArF) excimer laser, for example, the filter electrodes 21 and 22 are desirably made up of any one type selected from highly electroconductive metals including gold (Au), copper (Cu), titanium (Ti), aluminum (Al), chromium (Cr), molybdenum (Mo) tantalum (Ta), tungsten (W), and so forth, alloys of these metals, alloys containing two or more types thereof, or the like. These metal materials may have a layered structure of W/Ta, Ti/Al, Ti/Al/Ti, Cu/Ti, or the like, in order from an upper layer side for example, so as to raise physical properties of adhesion to a base (typically, substrates 23 and 24) and so forth. Examples of inorganic electroconductive materials include indium tin oxide (ITO), indium zinc oxide (IZO), indium gallium zinc oxide (IGZO), zinc oxide (ZnO), and so forth. Examples of organic electroconductive materials include polyacetylenes, polythiophenes, and so forth. The filter electrodes 21 and 22 may be made up of two or more of a metal material, an inorganic electroconductive material, and an organic electroconductive material, which are layered.

The first substrate 23 is a component that supports the differently-shaped electrode 21. In this example, the first substrate 23 includes the differently-shaped electrode 21, and the deflection electrode 26 that will be described later, at positions that are separated from each other with respect to the flow direction, as illustrated in FIG. 1. Also, the second substrate 24 is a component that supports the planar electrode 22. In this example, the second substrate 24 includes the planar electrode 22, and the detection electrode 27, at positions that are separated from each other with respect to the flow direction. The first substrate 23 and the second substrate 24 are disposed such that the supporting faces on which these electrodes are provided opposing each other. Hereinafter, when differentiation does not have to be made between the first substrate 23 and the second substrate 24, these will be collectively referred to as “substrates 23 and 24”. The shapes of the substrates 23 and 24 are not limited in particular, as long as the differently-shaped electrode 21 and the planar electrode 22, and the detection electrode 27 and the deflection electrode 26, can be supported in a substantially parallel manner, in a predetermined orientation. The second substrate 24 according to the present embodiment has a rectangular plate shape that is long with respect to the flow direction. On the other hand, the first substrate 23 according to the present embodiment has a rectangular plate shape that is long with respect to the flow direction, generally the same way as with the second substrate 24, but includes steps on the supporting face so as to be capable of stably supporting the regions 21A to 21D of the differently-shaped electrode 21 from the rear side thereof.

In detail, the first substrate 23 includes a plurality of portions provided longitudinally along the flow direction. These portions are a first portion 23A, a second portion 23B, a third portion 23C, and a fourth portion 23D. The first portion 23A, second portion 23B, third portion 23C, and fourth portion 23D are disposed arrayed adjacently to each other with respect to the intersecting direction in plan view (as viewed in the electric field direction). These four portions are arrayed in the order of first portion 23A, second portion 23B, third portion 23C, and fourth portion 23D, in plan view, in the present embodiment. These four portions may each have stepped shapes in which the second portion 23B protrudes more toward the second substrate 24 with respect to the first portion 23A, the third portion 23C with respect to the second portion 23B, and the fourth portion 23D with respect to the third portion 23C, such that the distance of separation as to the second substrate 24 is reduced in this order. In the present embodiment, a rear face on the opposite side from the opposing face of the first substrate 23 is flat. The portions 23A to 23D are integrally continuous, and thus make up the first substrate 23. The first portion 23A, second portion 23B, third portion 23C, and fourth portion 23D respectively support the first region 21A, second region 21B, third region 21C, and fourth region 21D, of the differently-shaped electrode 21. The second substrate 24 also supports the planar electrode 22 so as to oppose the differently-shaped electrode 21.

The substrates 23 and 24 in this example may be made up of various types of insulating materials having electrical insulating properties. Examples of insulating materials include materials with a volume resistivity at room temperature (e.g., 25° C.) of 10⁷ Ωcm or higher (e.g., 10¹⁰ Ωcm or higher, 10¹² Ωcm or higher, and further 10¹⁵ Ωcm or higher), and for example may be an organic material, inorganic material, or the like, having the above volume resistivity. In a case of fabricating the first substrate 23 by lithography technology, glass substrates are desirably used as the substrates 23 and 24, and in a case of forming by resin molding, various types of insulating resin material are desirably used, although this is not limiting. While there is no limit regarding the thicknesses of the substrates 23 and 24, an example of around 0.1 to 1 mm (e.g., 0.5 mm, 0.7 mm, and so forth) can be exemplified.

The deflection electrode 26 is a component that deflects specimen ions toward the detection electrode 27, such that the specimen ions introduced into the detection cell 20 are collected by the detection electrode 27. In the present embodiment, the deflection electrode 26 is an example of a downstream-side electrode in the present technology. The deflection electrode 26 includes a first deflection electrode 26A, a second deflection electrode 26B, a third deflection electrode 26C, and a fourth deflection electrode 26D. The first deflection electrode 26A, second deflection electrode 26B, third deflection electrode 26C, and fourth deflection electrode 26D are respectively disposed on the downstream side of the first region 21A, second region 21B, third region 21C, and fourth region 21D, of the differently-shaped electrode 21, and are supported by the first portion 23A, second portion 23B, third portion 23C, and fourth portion 23D of the first substrate 23. These deflection electrodes 26A to 26D are connected to a third potential adjusting unit 43 of the control device 40 that will be described later. The deflection electrode 26 is configured to be capable of forming an electric field that deflects specimen ions between the deflection electrode 26 and the detection electrode 27 toward the detection electrode 27, by voltage being applied thereto by the third potential adjusting unit 43 that will be described later. Between the deflection electrode 26 and the detection electrode 27 is a detection space, for detecting specimen ions passing through the ion separation space.

The detection electrode 27 is a component that receives charges of specimen ions by the specimen ions introduced into the detection cell 20 coming into contact therewith. The detection electrode 27 according to the present embodiment is an example of an opposing electrode. The detection electrode 27 is disposed on the downstream side of the planar electrode 22. The detection electrode 27 includes a first detection electrode 27A, a second detection electrode 27B, a third detection electrode 27C, and a fourth detection electrode 27D. The first detection electrode 27A, second detection electrode 27B, third detection electrode 27C, and fourth detection electrode 27D are supported on the downstream-side of the opposing face of the second substrate 24, so as to respectively face the first deflection electrode 26A, second deflection electrode 26B, third deflection electrode 26C, and fourth deflection electrode 26D. The surfaces of the detection electrodes 27A to 27D on the side opposing the deflection electrodes 26A to 26D are each collecting faces that receive specimen ions. Also, the detection electrodes 27A to 27D are connected to a measuring unit 44 of the control device 40. Such a configuration of the detection electrode 27 enables the control device 40 to comprehend the amount of specimen ions received on the collection face.

Now, the specimen ions that passed through a filtering space between the first region 21A of the differently-shaped electrode 21 and the planar electrode 22 are introduced to the detection space between the first deflection electrode 26A and the first detection electrode 27A, and are captured by the first detection electrode 27A. In the same way, the specimen ions that passed through filtering spaces between the second to fourth regions 21B to 21D and the planar electrode 22 are respectively introduced to the detection spaces between the second to fourth deflection electrodes 26B to 26D and the second to fourth detection electrodes 27B to 27D, and are captured by the second to fourth detection electrodes 27B to 27D. As described earlier, the magnitudes of the electric fields E1 to E4 formed between the regions 21A to 21D of the differently-shaped electrode 21 and the planar electrode 22 differ from each other, and accordingly the specimen ions passing through the filtering spaces of the differently-shaped electrode 21 differ according to each region. As a result, the information detected by the first to fourth detection electrodes 27A to 27D is information regarding specimen ions that are different from each other.

The shapes of the detection electrode 27 and the deflection electrode 26 are not limited in particular. The thicknesses of the detection electrode 27 and the deflection electrode 26 may each be no more than around 1 μm for example, and typically may be no more than around 600 nm, for example no more than around 500 nm, no more than around 400 nm, no more than around 200 nm, or the like. Also, the thicknesses of the detection electrode 27 and the deflection electrode 26 may independently be no less than around 10 nm, and typically may be no less than around 50 nm, for example no less than around 100 nm. The materials making up the detection electrode 27 and the deflection electrode 26, and the structure thereof, may be the same as those of the above filter electrodes 21 and 22.

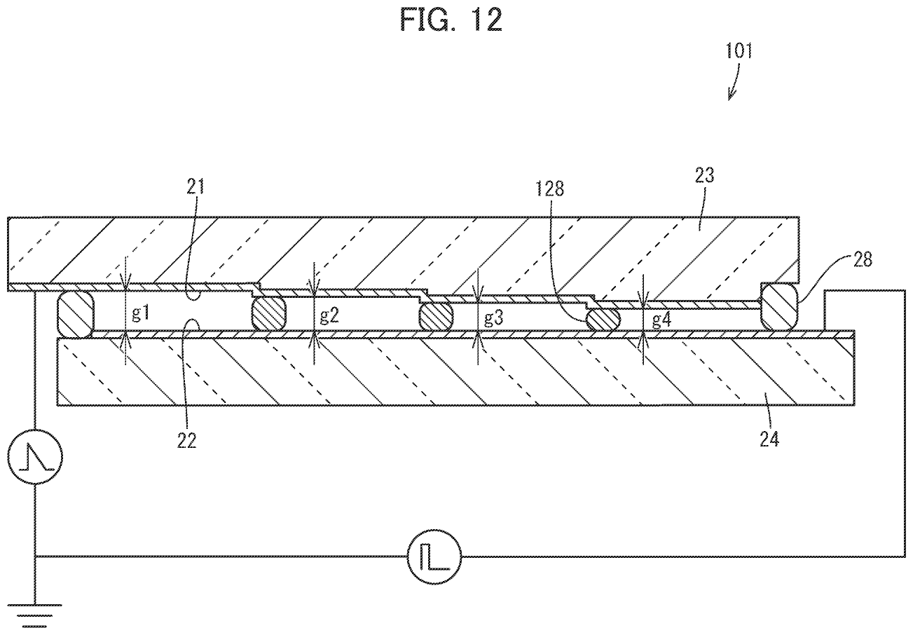

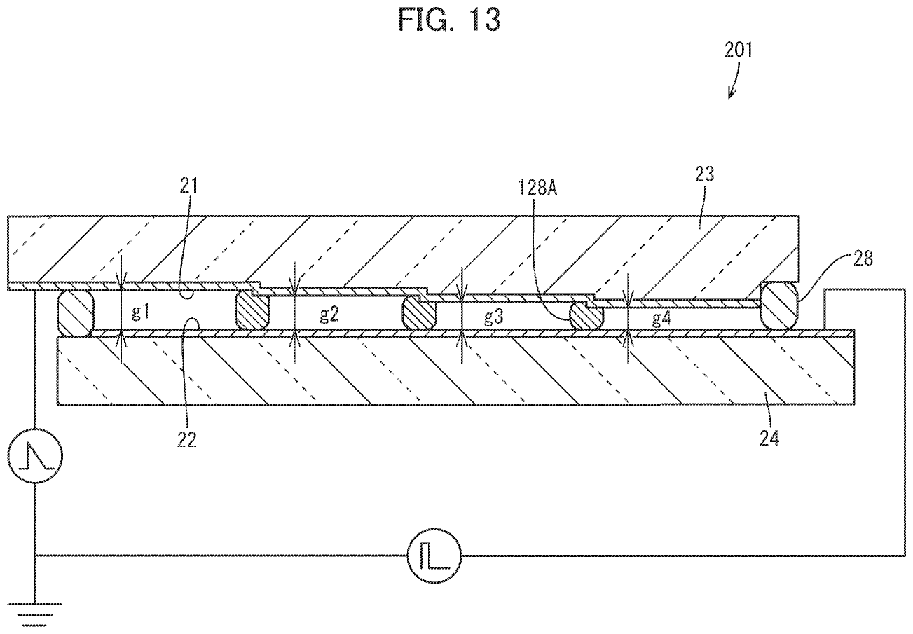

Note that spacers 28 (see FIG. 12, etc.) may be disposed between the substrates 23 and 24, in order to stably maintain the distance of separation between the filter electrodes 21 and 22. The shape, configuration, and so forth, of the spacers 28 are not limited in particular, as long as the distance of separation of the filter electrodes 21 and 22 can be appropriately maintained. Also, the spacers 28 may be disposed on at least one of the differently-shaped electrode 21 and the planar electrode 22. In a case of disposing the spacers 28 on the differently-shaped electrode 21 and/or the planar electrode 22, the spacers 28 are desirably made up of a material having electrical insulating properties. The spacers 28 may include spacer particles (e.g., stainless steel beads, glass beads, or the like) having a predetermined grain size (e.g., no less than around approximately 30 μm and no more than around 500 μm, typically no less than around approximately 50 μm and no more than around 300 μm, which is the first gap g1), and a binder for fixing the spacer particles to the substrates 23 and 24 (or filter electrodes 21 and 22), although this is not limiting. The binder may be various types of binder resins, elastomer materials, or the like. The spacers 28 may include a matrix resin material for filling in gaps between the spacer particles. Providing the spacers 28 continuously or intermittently along the flow direction is desirable since a channel for the carrier gas containing the specimen ions can be formed. In the present embodiment, the spacers 28 are formed as two lines that continuously extend following the flow direction, at both ends of the filter electrodes 21 and 22, the detection electrode 27, and the deflection electrode 26. Accordingly, the ion separation space is surrounded on four sides by the two rows of spacers 28 and the filter electrodes 21 and 22, thereby forming a channel. Also, the detection space is surrounded on four sides by the two rows of spacers 28 and the detection electrode 27, and the deflection electrode 26, thereby forming a channel. Also, between the ion separation space and the detection space is surrounded on four sides by the two rows of spacers 28 and the substrates 23 and 24, thereby forming a channel.

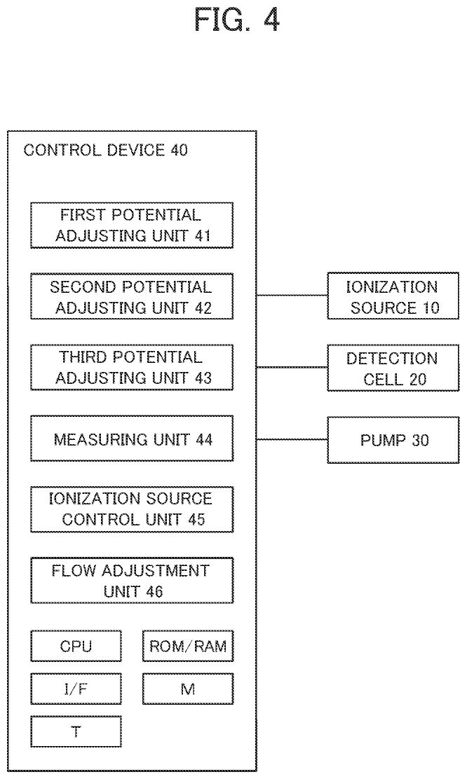

The control device 40 is a component that controls driving of the analyzing device 1. As illustrated in FIG. 4, the control device 40 is made up of a microcomputer that has an interface (I/F) that transmits and receives various types of information and so forth, a central processing unit (CPU) that executes commands of a control program, a storage unit M that stores various types of information, a timer T that has clocking functions, and so forth. The storage unit M includes read only memory (ROM) that stores programs to be executed by the CPU, and random access memory (RAM) that is used as a working area to which the programs are loaded. The ROM may store computer programs, databases, and data tables used for driving, for example, each of the first potential adjusting unit 41 to the third potential adjusting unit 43 which will be described later, and computer programs, databases, and tables and so forth used for various types of analyzing processing based on amounts of specimen ions detected by the measuring unit 44, although not limited thereto. Also, the storage unit M can also store ID information of analytes, information relating to amounts of specimen ions that are detected, information used for various types of analyzing processing, information relating to analysis results, and so forth.

The control device 40 includes the first potential adjusting unit 41, the second potential adjusting unit 42, the third potential adjusting unit 43, the measuring unit 44, an ionization source control unit 45, and a flow adjustment unit 46. These units may each be configured as hardware independently, or may be functionally realized by the CPU executing programs.

The control device 40 according to the present embodiment is connected to the detection cell 20. More specifically, the first potential adjusting unit 41, the second potential adjusting unit 42, the third potential adjusting unit 43, and the measuring unit 44, of the control device 40, are connected to the differently-shaped electrode 21, the planar electrode 22, the deflection electrode 26, and the detection electrode 27, and are configured to be able to perform control of operations thereof, and detect potential states thereof. Also, the control device 40 according to the present embodiment is additionally connected to the ionization source 10 and the pump 30, and is capable of connecting to an external electric power source (omitted from illustration) for supplying electric power to the analyzing device 1.

The first potential adjusting unit 41 is a component that applies distributed voltage across at least the pair of the filter electrodes 21 and 22, and controls this distributed voltage. Upon distributed voltage being applied across the filter electrodes 21 and 22, an electric field is formed between the filter electrodes 21 and 22. In the present embodiment, the first potential adjusting unit 41 is arranged to apply distributed voltage to the planar electrode 22. Distributed voltage is a bipolar pulsed voltage exhibiting both polarities of positive and negative. Potential in both polarities of positive and negative typically is asymmetrically switched. The voltage waveform is an asymmetrical pulsed waveform in which a period TH of high-voltage level V_{H} in which a high electric field is formed, a period T_{L} of low-voltage level V_{L} in which a low electric field is formed, are alternatingly included. In this voltage waveform, the time average of voltage is set to be zero. Now, mobility of ions does not change in a low electric field, regardless of the intensity of the electric field, but the value thereof changes in a high electric field, dependent on the intensity of the electric field. Accordingly, the first potential adjusting unit 41 typically is connected to a variable-voltage generator such as a pulsed-voltage generating device or the like, and is arranged to be capable of applying square wave distributed voltage, for example. Note however, that the waveform of the distributed voltage is not limited to this, and may be a sine wave, an intermediate form between a square wave and a complex waveform, or the like.

A flow of carrier gas (typically neutral) containing specimen ions is formed at a regular flow speed in the ion separation space between the filter electrodes 21 and 22, by the flow adjustment unit 46, which will be described later, driving the pump 30. Now, a high electric field is formed in the ion separation space by voltage of the high-voltage level V_{H} being applied by the first potential adjusting unit 41. Also, a low electric field is formed in the ion separation space by voltage of the low-voltage level V_{L} being applied by the first potential adjusting unit 41. The polarity differs between the high electric field and the low electric field. When specimen ions are sent into such an environment in which asymmetrical electric fields are alternatingly generated, the specimen ions advance in a zig-zag manner, being alternatingly drawn by the differently-shaped electrode 21 and the planar electrode 22. At this time, specimen ions that are greatly deflected by the differently-shaped electrode 21 or the planar electrode 22 collide into the differently-shaped electrode 21 or the planar electrode 22, and are not able to pass the filter electrodes 21 and 22. Only specimen ions balanced between the differently-shaped electrode 21 and the planar electrode 22 pass the filter electrodes 21 and 22 and are sent to the detection electrode 27 on the downstream side.

The second potential adjusting unit 42 is a component that applies compensation voltage between the filter electrodes 21 and 22, and also controls this compensation voltage. As described above, only specimen ions that are balanced between the differently-shaped electrode 21 and the planar electrode 22, i.e., in a drift electric field formed therebetween, pass between the filter electrodes 21 and 22. The second potential adjusting unit 42 causes change in the types of ions passing the filter electrodes 21 and 22, by applying the compensation voltage superimposed on the distributed voltage DV across the filter electrodes 21 and 22. The compensation voltage is direct current voltage, and is applied generally uniformly across the filter electrodes 21 and 22. Also, the magnitude of the compensation voltage is changed by a regular rate of change and cycle T_{CV}, for each predetermined distributed voltage DV (in other words, change between a lower-limit voltage V_{CVL} to an upper-limit voltage V_{CVH}, at the cycle T_{CV}), for example. Thus, ion types with different mobilities can be sent into the detecting space in order.

The third potential adjusting unit 43 is a component that imparts a predetermined potential difference between the detection electrode 27 and the deflection electrode 26. Accordingly, the specimen ions passing through the ion separation space and entering the detection space can be deflected toward the detection electrode 27. In the present embodiment, the third potential adjusting unit 43 is connected to the deflection electrode 26, and is arranged to impart potential to the deflection electrode 26. The second potential adjusting unit 42 adjusts the potential of the deflection electrode 26, so that the deflection electrode 26 is high potential with respect to the detection electrode 27 if specimen ions introduced into the detection cell 20 are positive ions, and so that the deflection electrode 26 is low potential with respect to the detection electrode 27 if specimen ions introduced into the detection cell 20 are negative ions.

The measuring unit 44 is a component that detects a count of specimen ions arriving at the detection electrode 27. Upon coming into contact with the detection electrode 27, the specimen ions impart their charges to the detection electrode 27 and lose the charges. The detection electrode 27 receives charges in accordance with the charges that the arriving specimen ions have, and the count thereof. The measuring unit 44 is connected to the detection electrode 27, and acquires information relating to the charges received from the specimen ions arriving at the detection electrode 27, as electrical signals. The measuring unit 44 may be configured to not only measure the count of the specimen ions, but also to collaborate with the first potential adjusting unit 41, so as to be able to determine the specimen ions qualitatively and quantitatively. Information relating the count and so forth of the specimen ions measured by the measuring unit 44 is stored in the storage unit M, for example.

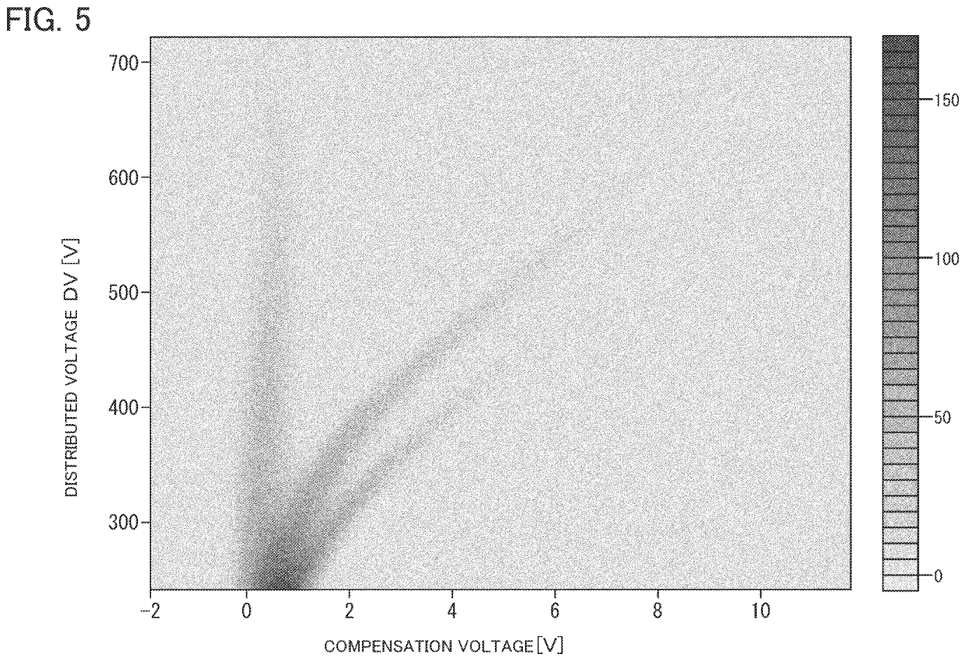

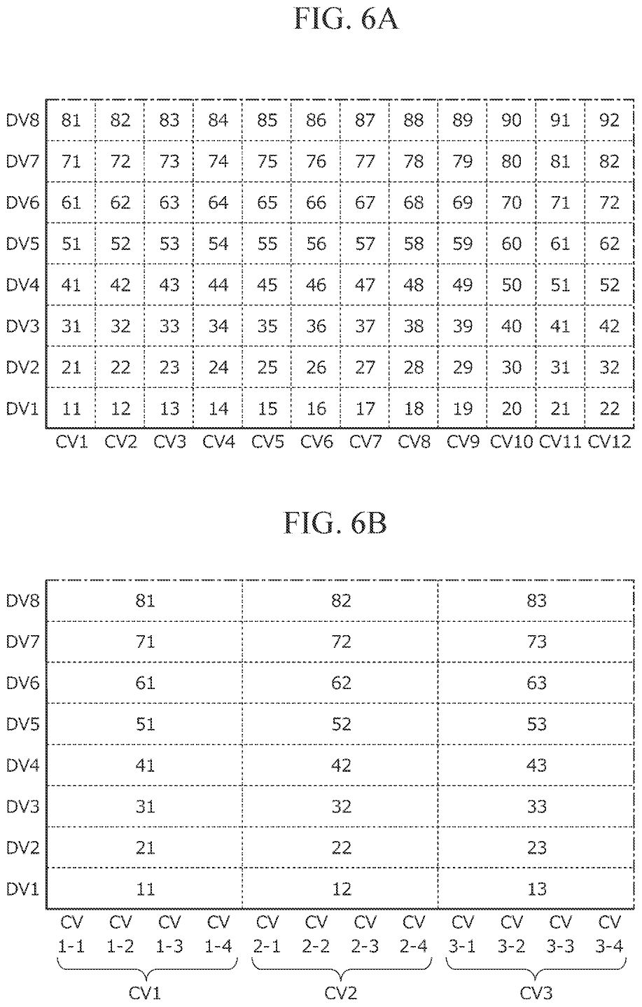

Thus, a FAIMS spectrum such as shown in FIG. 5 can be obtained from the relation between distributed voltage and compensation voltage, and the electrical signals from the detection electrode 27. Note that resolution can be raised in FAIMS analysis by increasing the number of steps (number of conditions) of distributed voltage and compensation voltage. In order to use a conventional parallel-plate detection cell to obtain the FAIMS spectrum (partial) such as shown in FIG. 5, the first potential adjusting unit 41 has to perform variance of distributed voltage DV under eight conditions, and the second potential adjusting unit 42 to perform variance of compensation voltage CV under 12 conditions, for a total of 96 conditions, as conceptually shown in FIG. 6A, for example. The amount of time that FAIMS analysis takes can be generally comprehended on the basis of the following Expression 1. It can be seen that an increase in the number of analysis conditions normally leads to an increase in measurement time accordingly. Now, by using the detection cell 20 according to the present technology and the second potential adjusting unit 42 applying a predetermined compensation voltage CV1 to the differently-shaped electrode 21, an electric field is formed that is the same as applying four compensation voltages CV1-1 to CV1-4 across the filter electrodes 21 and 22, as conceptually shown in FIG. 6B, for example. In other words, a filter space is formed that is the same as applying n different filter voltages Vf (five compensation voltages in the present embodiment), by applying a predetermined filter voltage Vf to the filter electrodes 21 and 22. Thus, according to the present technology, FAIMS analysis can be performed with high resolution, while simplifying the application conditions of the filter voltage Vf (the compensation voltage CV in the present embodiment). Note that in Expression 1 below, t_{scan} represents measurement time, nDV represents the number of steps of distributed voltage (normally 10 to 100), t_{DV} represents the set time for distributed voltage (normally 10 to 500 ms), nCV represents the number of steps of compensation voltage (normally 100 to 1000), tCV represents the set time for compensation voltage (normally 0.1 to 2 ms), tₛₐₘₚₗₑ represents the amount of time taken for A-to-D conversion (normally 0.1 to 5 ms), and tₛₚₜ represents the amount of time taken for signal processing (normally 1 to 5 ms), and can be referenced in “Anttalainen et al (2019), Possible strategy to use differential mobility spectrometry in real time applications, Int. J. Ion Mobil. Spec.”
Expression 1

The ionization source control unit 45 is connected to the ionization source 10, and is configured to be capable of controlling operations of the ionization source 10. The ionization source control unit 45 is configured to be capable

t_{scan}=n_{DV}×{t_{DV}×n_{CV}×(t_{CV}+tₛₐₘₚₗₑ+tₛₚₜ)}

of switching the polarity of the specimen ions being generated, between positive ions and negative ions, by switching the polarity of the voltage applied to the needle electrode in the ionization source 10 between positive and negative, for example. While this is not limiting, when the ionization source control unit 45 generates specimen ions that are negative, the first potential adjusting unit 41, the second potential adjusting unit 42, and the third potential adjusting unit 43 adjust the voltage applied to the filter electrodes 21 and 22 and the deflection electrode 26, so that the specimen ions that are negative can pass the filter electrodes 21 and 22 and arrive at the detection electrode 27. Also, when the ionization source control unit 45 generates specimen ions that are positive, the first potential adjusting unit 41, the second potential adjusting unit 42, and the third potential adjusting unit 43 adjust the voltage applied to the filter electrodes 21 and 22 and the deflection electrode 26, so that the specimen ions that are positive can pass the filter electrodes 21 and 22, and arrive at the detection electrode 27.

The flow adjustment unit 46 is connected to the pump 30, and is configured to be capable of controlling operation of the pump 30. The flow adjustment unit 46 is arranged to be capable of adjusting the flow speed and so forth of gas within the detection cell 20 by controlling, for example, the timings of driving and stopping the pump 30, and rotation speed of a fan provided to the pump 30.

A manufacturing method of the above detection cell 20 will be described below. The detection cell 20 according to the present technology can be manufactured by generally following the procedures below. A case of forming the differently-shaped electrode 21 on one first substrate 23 is illustrated below in the drawings referenced for the purpose of reference. However, the differently-shaped electrode 21 may be formed on a mother substrate in which a plurality of first substrates 23 are connected in an array, with reference to the drawings and the description. Also, a process 2 may be applied to formation of the planar electrode 22 onto the second substrate 24.

Process 1: preparation of first substrate 23
Process 2: formation of differently-shaped electrode 21 upon first substrate 23
Process 3: assembly of detection cell 20

As described above, the filter electrodes 21 and 22, the deflection electrode 26, and the detection electrode 27 can be thin-film like. Accordingly, these electrodes can be suitably fabricated in process 2 by directly performing film formation on the supporting faces of the first substrate 23 and the second substrate 24 by thin-film formation technology and lithography technology and the like. Also, the first substrate 23 has steps of complicated shapes on the supporting face, and accordingly the first substrate 23 is desirably prepared in a process 1, prior to electrode formation. The fabrication method of the first substrate 23 is not limited. First, three fabrication methods of a substrate with an electrode (process 1 and process 2) will be described below.

### 1. Method Using Photolithography

### Process 1-1

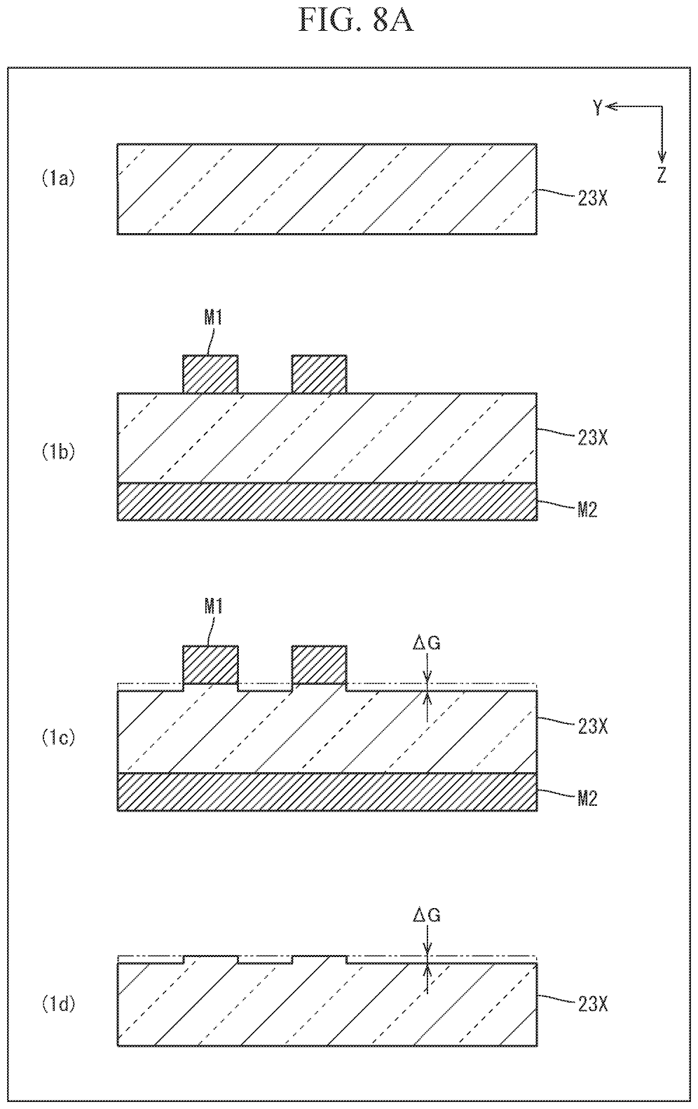

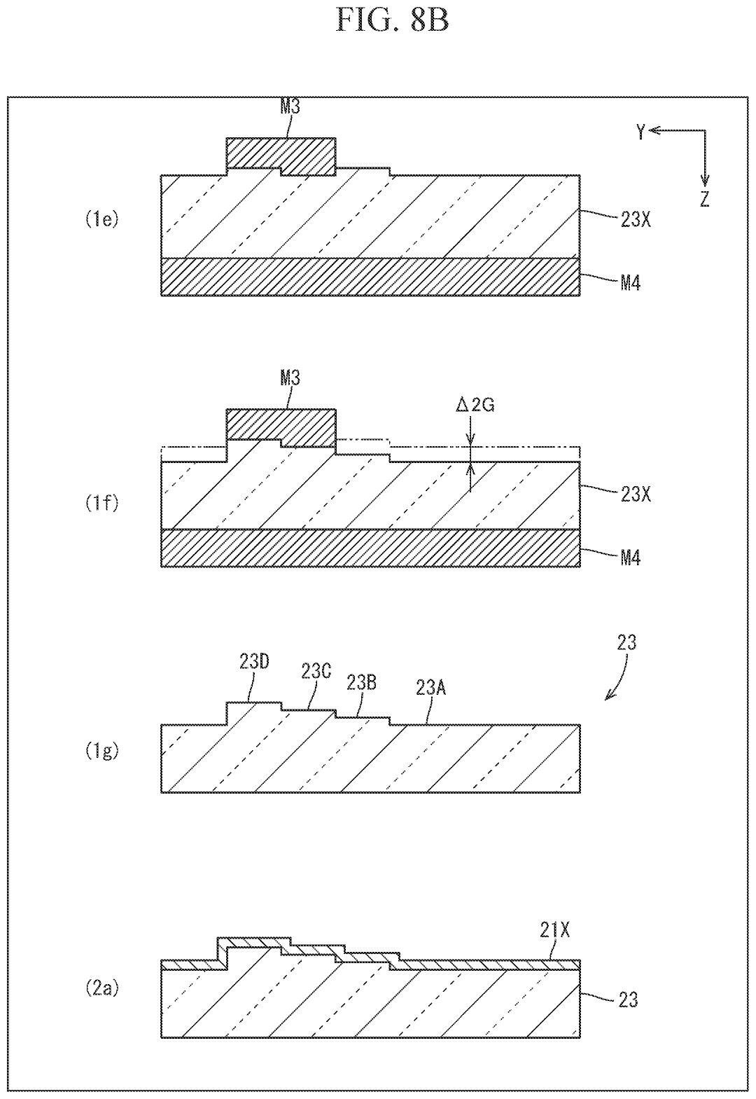

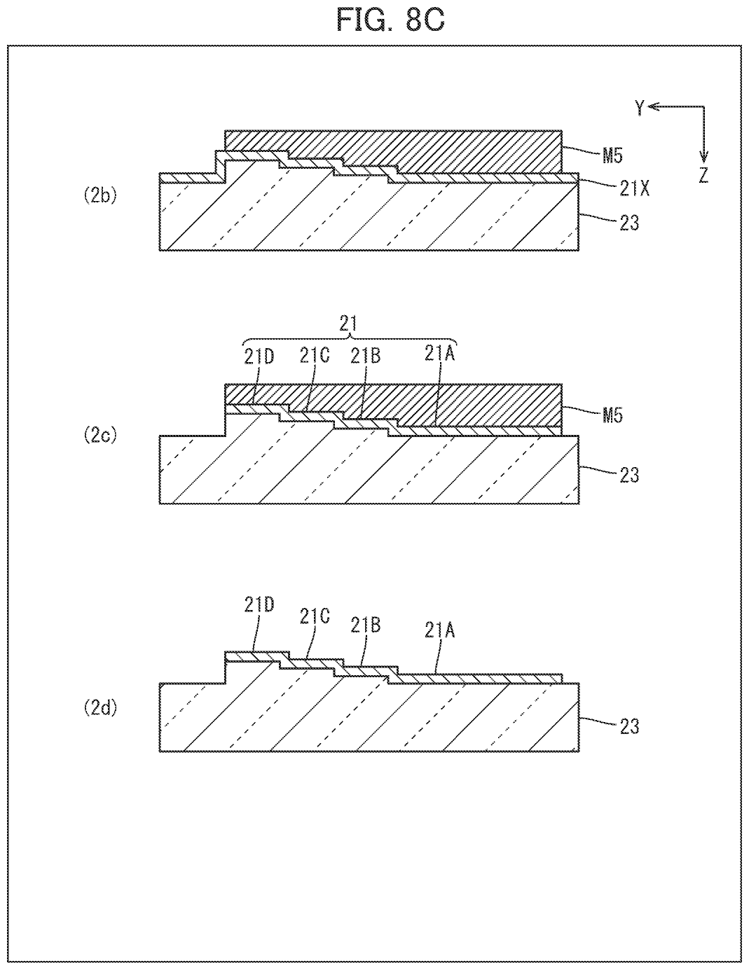

First, as illustrated FIG. 8A, a first substrate 23X that is flat and made of a glass substrate is prepared in process (1a). Next, in process (1b), patterning by a resist M1 is performed on a portion that corresponds to the fourth portion 23D that protrudes the farthest out of the supporting face of the first substrate 23X that is flat, and a portion corresponding to the second portion 23B that is two portions away. Also, the entire rear face is coated by a resist M2 to keep the rear face from being etched in a later process. In process (1c), the portions of the first substrate 23X that is flat which are not covered by the resists M1 and M2 are etched (e.g., wet etching for glass) by an amount corresponding to gap ΔG (first etching). In process (1d), the resists M1 and M2 are removed from the first substrate 23X following the first etching, and rinsing is performed. Next, as illustrated in FIG. 8B, in process (1e), patterning by a resist M3 is performed on the portion that corresponds to the fourth portion 23D that protrudes the farthest out of the supporting face of the first substrate 23X following the first etching, and a portion corresponding to third portion 23C adjacent thereto. Also, the entire rear face thereof is coated by a resist M4, in the same way as in process (1b). In process (1f), the portions of the first substrate 23X following the first etching that are not covered by resist are etched by an amount corresponding to two gaps (2×ΔG) (second etching). In process (1g), the resist is removed from the first substrate 23X following the second etching, and rinsing is performed. Accordingly, the first substrate 23 including the first portion 23A, the second portion 23B, the third portion 23C, and the fourth portion 23D can be prepared.

### Process 2-1

Next, the differently-shaped electrode 21 and the deflection electrode 26 are fabricated on the supporting face of the first substrate 23. That is to say, in process (2a), film formation of an electrode layer 21X is performed on the entire face of the supporting face of the first substrate 23. The electrode layer 21X can be formed using the material making up the above filter electrodes 21 and 22. In a case in which the electrode layer 21X is made up of Mo, for example, a Mo layer is deposited at a thickness of 100 to 600 nm by sputtering, plating or the like. Besides, Mo, metal materials such as Ti, Al, Cu, Au, W, Ta, MoW, and so forth, and electroconductive oxides such as ITO, IZO, ZnO, and so forth, may be used for forming. Further, in order to improve adhesion, the electrode layer 21X may have a layered structure of a combination of metal layers, such as W/Ta, Ti/Al, Ti/Al/Ti, Cu/Ti, or the like, from the upper layer side.

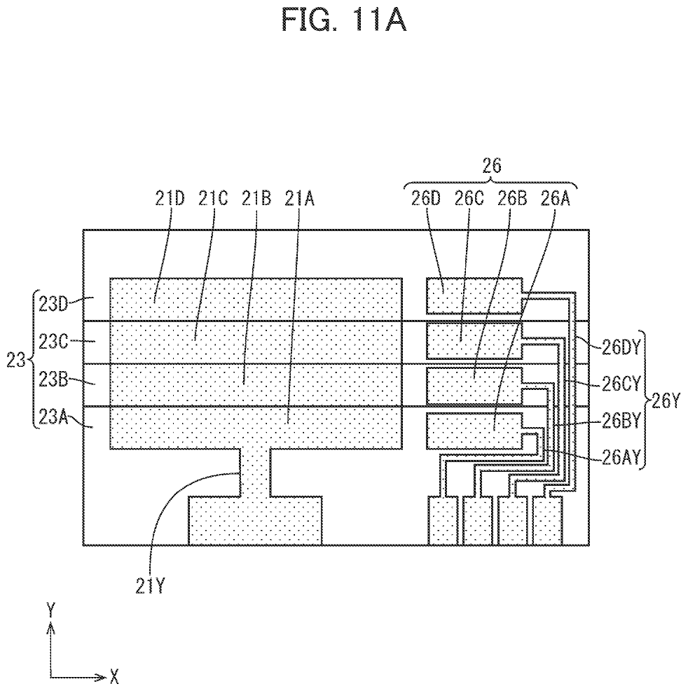

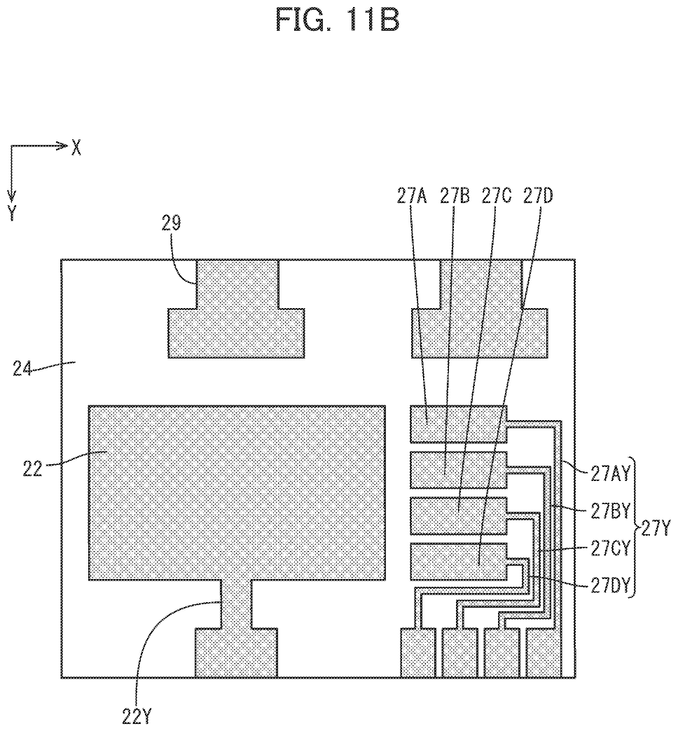

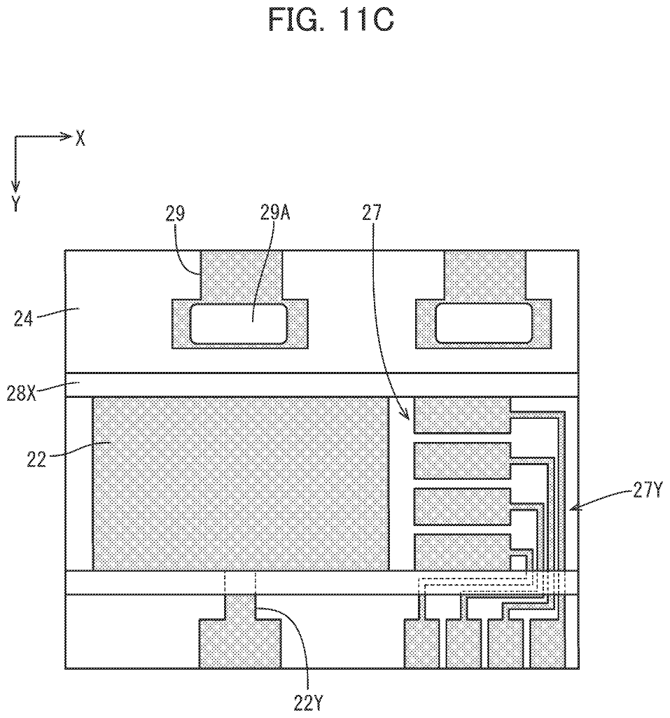

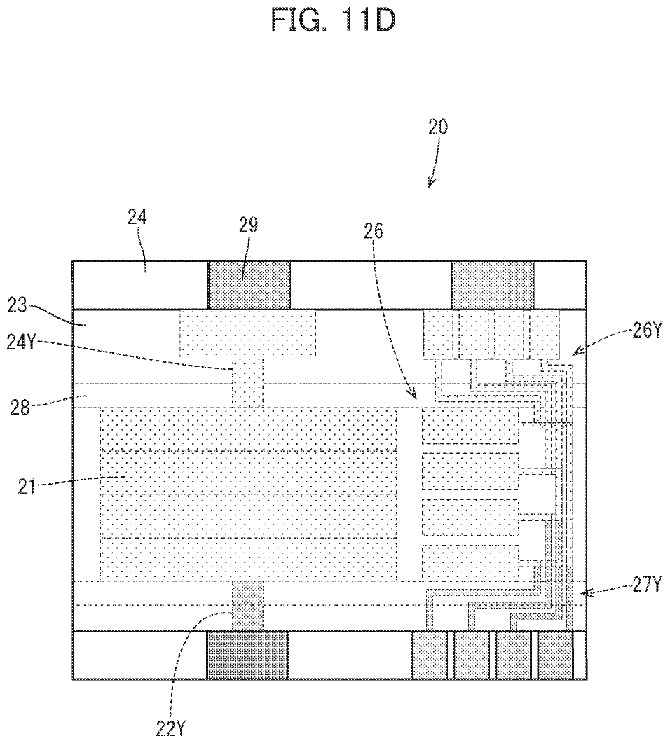

At this time, as illustrated in FIG. 11A, wiring portions 21Y, 26Y, and so forth, which extend to an end portion of the first substrate 23, are desirably formed at the same time for electrical connection of the differently-shaped electrode 21 and the deflection electrode 26 to the control device 40 and so forth. Note that aggregating external connection terminals for application of field voltage on one of the substrates 23 and 24 (e.g., on the second substrate 24) is conceivable. In this case, an arrangement is desirable in which this second substrate 24 is larger than the other first substrate 23, and a connecting terminal 29 for connection with the wiring portion 21Y on the other first substrate 23 is formed on the second substrate 24 and extended to an end portion of the second substrate 24, as illustrated in FIG. 11B, for example.

Next, as illustrated in FIG. 8C, in process (2b), portions corresponding to the differently-shaped electrode 21 and the deflection electrode 26 are patterned by a resist M5. In process (2c), portions of the electrode layer 21X on the first substrate 23 that are not covered with resist are etched (e.g., wet etching for metal) (third etching). In process (2d), the resist is removed from the first substrate 23 following the third etching, and rinsing is performed. Thus, the first substrate 23 including the differently-shaped electrode 21 that includes the first region 21A, the second region 21B, the third region 21C, and the fourth region 21D can be prepared.

### 2. Method Using Permanent Resist Film

### Process 1-2

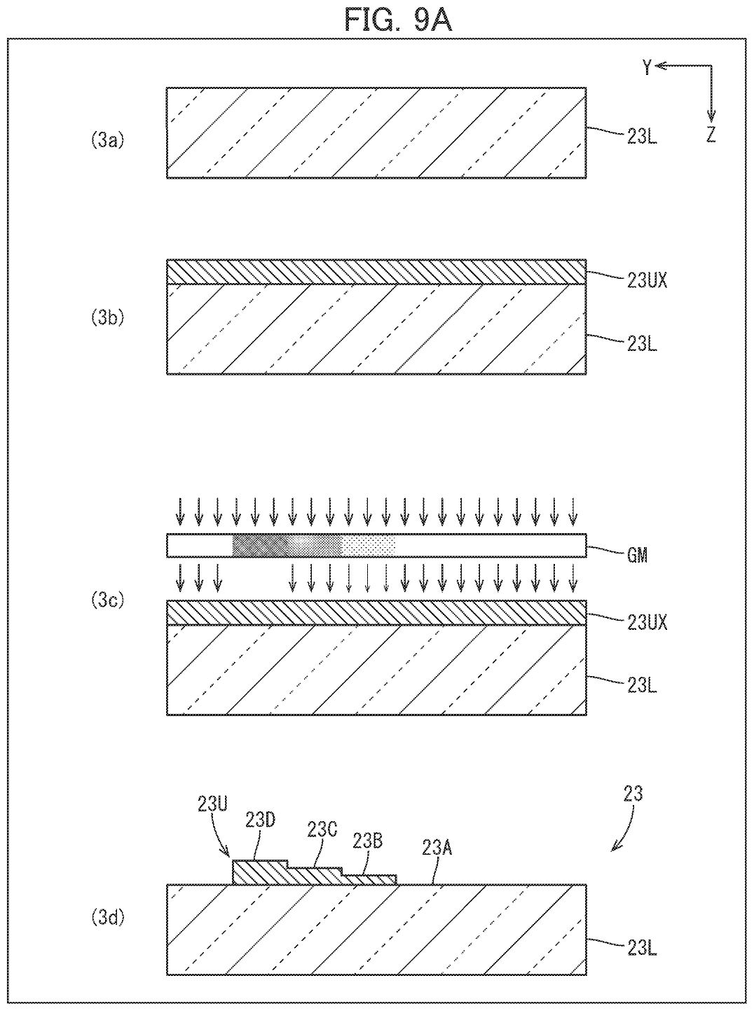

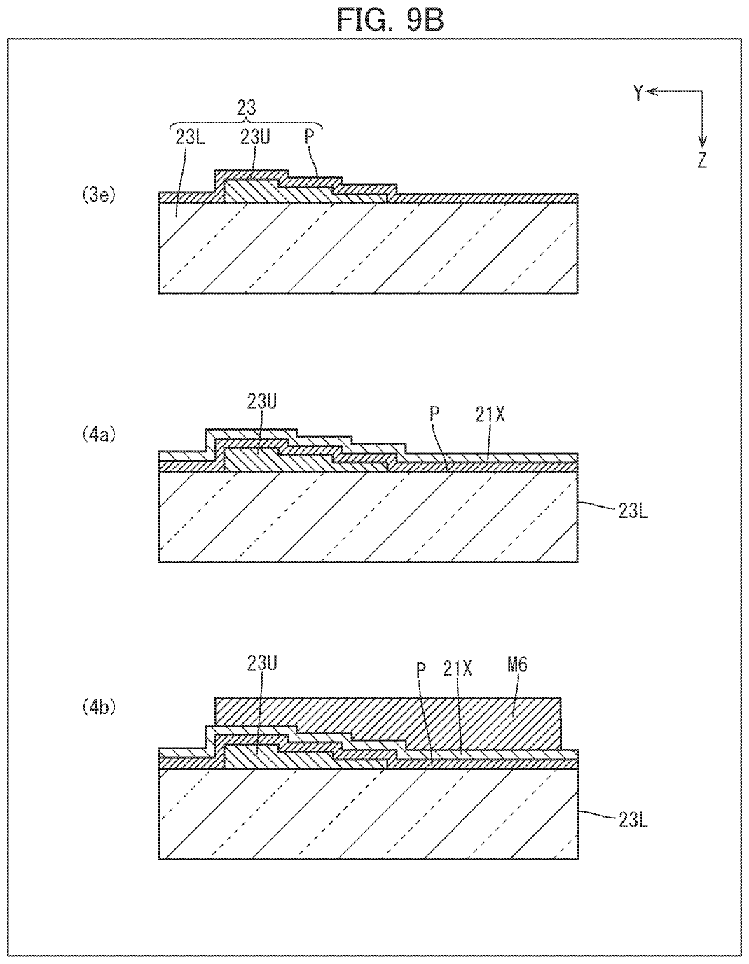

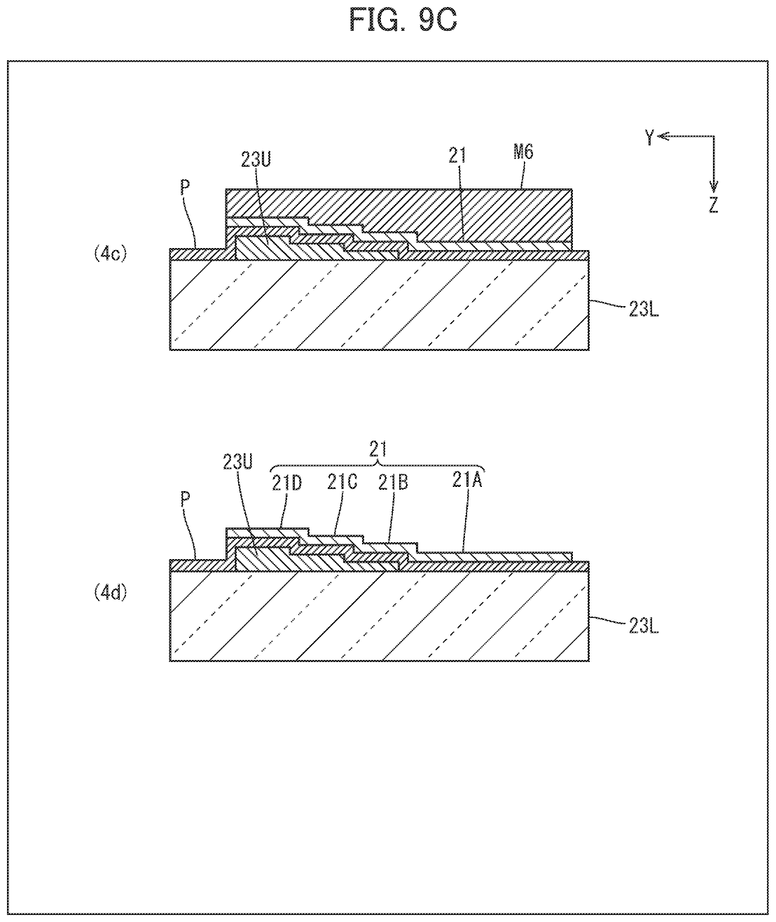

In a method using permanent resist film, a first substrate 23 generally made up of a foundation portion 23L and a stepped portion 23U is fabricated. First, as illustrated in FIG. 9A, in process (3a), the foundation portion 23L that is flat and made of a glass substrate is prepared. Next, in process (3b), a permanent resist that has photosensitivity is coated on the entire supporting face of the foundation portion 23L to a predetermined film thickness, thereby forming a permanent film 23UX. The film thickness here is ΔG×(n minus 1), in which n is the number of regions, and is a natural number that is 2 or greater. In this case, n=4. A synthetic resin such as epoxy resin or the like, having photosensitivity and durability (may be a so-called permanent photoresist material), can be used as the permanent resist. In process (3c), a gray-tone mask is used to expose and develop the permanent film 23UX. The gray-tone mask is also referred to as a three-dimensional mask and so forth, and includes slits below the resolution of an exposing device. Exposing is realized at a predetermined density in accordance with the density of the slits, utilizing shielding of part of the light by the slit portions. The gray-tone mask is configured such that the amount of light transmitted is in three stages (n minus 1 stages). For example, the amount of light transmitted is controlled such that the degree of exposure of the portion corresponding to the fourth portion 23D that protrudes the farthest is zero (0%), the degree of exposure of the portion corresponding to the third portion 23C is ⅓, the degree of exposure of the portion corresponding to the second portion 23B is ⅔, and the degree of exposure of the portion corresponding to the first portion 23A is 1 (100%). Accordingly, in process (3d), the stepped portion 23U making up the second portion 23B, the third portion 23C, and the fourth portion 23D, is integrally formed on the foundation portion 23L making up the first portion 23A. There is a possibility that the permanent resist material may have inferior chemical stability, and accordingly in process (3e), a passivation film P is additionally formed on the supporting faces of the stepped portion 23U and the foundation portion 23L, as illustrated in FIG. 9B. The passivation film P can be made of an insulating material such as, for example, silicon nitride (also written as Si₃N₄ or SiN, for example), silicon oxynitride (also written as SiON, for example), and so forth. Thus, the first substrate 23 including the first portion 23A, the second portion 23B, the third portion 23C, and the fourth portion 23D can be obtained.

### Process 2-2

Next, the differently-shaped electrode 21 and the deflection electrode 26 are fabricated on the supporting face of the first substrate 23. As illustrated in FIGS. 9B to 9C, a formation process (4a) of the electrode layer 21X, a patterning process (4b) of a resist M6, an etching process (4c) of the electrode layer 21X, and a removal and rinsing process (4d) of the resist M6 are in common with process 2-1, and accordingly repetitive description will be omitted.

### 3. Method Using Resin Molding

### Process 1-3

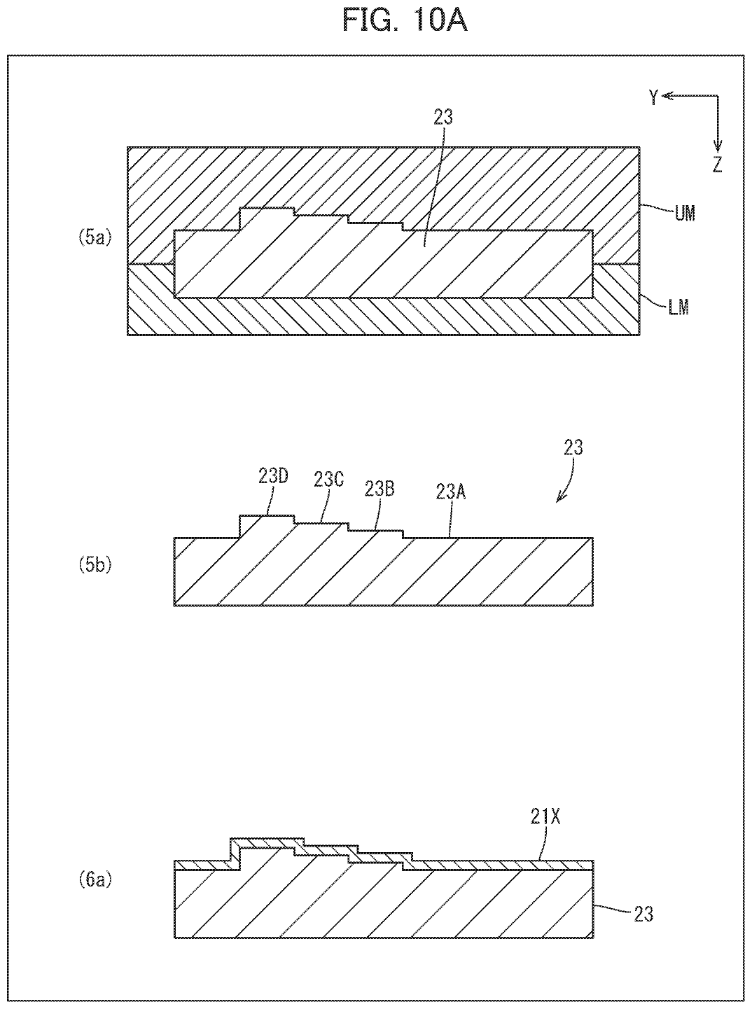

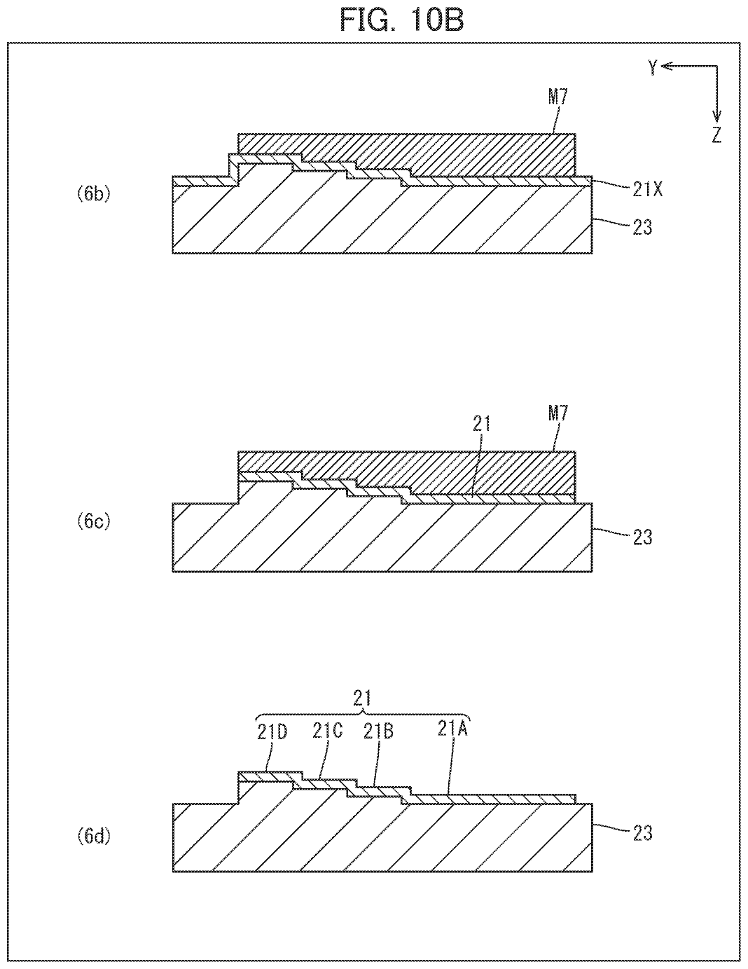

The substrates 23 and 24 can also be made up of a synthetic resin material. In this case, the substrates 23 and 24 can be suitably fabricated by the following resin molding method. That is to say, moldpieces UM and LM that have a cavity corresponding to the first substrate 23 are first prepared as illustrated in process (5a) in FIG. 10A, and a synthetic resin material in a molten state is injected into the cavity of the moldpieces UM and LM. After the synthetic resin has cured within the moldpieces UM and LM, the first substrate 23 formed by curing in the mold is released, as illustrated in process (5b). Thus, the first substrate 23 including the first portion 23A, the second portion 23B, the third portion 23C, and the fourth portion 23D can be obtained.

### Process 2-3

Next, the differently-shaped electrode 21 and the deflection electrode 26 are fabricated on the supporting face of the first substrate 23. A formation process (6a) of the electrode layer 21X, a patterning process (6b) of a resist M7, an etching process (6c) of the electrode layer 21X, and a removal and rinsing process (6d) of the resist M7 are in common with process 2-1, and accordingly repetitive description will be omitted.

### Process 3

In a process 3, the first substrate 23 and the second substrate 24 upon which the respective electrodes are formed are bonded to each other. In the bonding of the substrates 23 and 24, the front and rear of the first substrate 23 is reversed and the substrates 23 and 24 are overlaid, so that the differently-shaped electrode 21 and the planar electrode 22, and also the deflection electrode 26 and the detection electrode 27 oppose each other. Also, a spacer material 28X is supplied upon the first substrate 23, so that the first substrate 23 and the second substrate 24 can maintain a predetermined filter gap. In the present embodiment, two rows of the spacer material 28X may be supplied by supply equipment such as a dispenser or the like, so as to sandwich the differently-shaped electrode 21 and the detection electrode 27 following the flow direction, as illustrated in FIG. 11C for example. However, the spacer material 28X may be supplied to be overlaid on both end portions of the differently-shaped electrode 21 and the detection electrode 27. The spacer material 28X according to the present embodiment is an insulating sealing material (e.g., a dry-curing resin composition) in a paste form that contains spacer particles of a predetermined grain size. The second substrate 24 is placed upon the first substrate 23 as illustrated in FIG. 11D before the spacer material 28X cures, thereby fixing the two to each other. At this time, the end portion of the wiring portion 21Y is connected to the connecting terminal 29 between the substrates 23 and 24. Also, an end portion of a wiring portion 22Y and the connecting terminal 29 are desirably exposed from the first substrate 23 in plan view. The positions at which the electrodes are formed is desirably adjusted so that the detection electrode 27 and the deflection electrode 26 oppose each other. Note that in order to connect the wiring portion 21Y of the first substrate 23 with the second substrate 24, and the wiring portion 22Y of the second substrate 24 with the first substrate 23, in a sure manner, an electroconductive paste 29A (e.g., a silver paste that is omitted from illustration) may be interposed in these connecting portions.

After bonding the first substrate 23 and the second substrate 24 to each other, the first substrate 23 and the second substrate 24 may be pressed, subjected to annealing processing, or the like, as appropriate, to increase the adhesion of the components, although this is not an indispensable process. Thus, the detection cell 20 is obtained.

### Configuration and Effects of Embodiment 1

In the above detection cell 20, the differently-shaped electrode 21 (one of the pair of filter electrodes) includes the first region 21A provided following the flow direction, and the second region 21B that is disposed arrayed with the first region 21A with respect to the intersecting direction intersecting the flow direction, and that protrudes so that the distance of separation as to the planar electrode 22 (other electrode) is smaller than that of the first region 21A. According to such a configuration, the distance of separation between the filter electrodes 21 and 22 is different depending on the region, such as the first gap g1 and the second gap g2 that is smaller than the first gap g1. When voltage is applied to such filter electrodes 21 and 22, the electric fields formed between these electrodes are such that the second electric field E2 formed corresponding to the second region 21B is greater than the first electric field E1 formed corresponding to the first region 21A. That is to say, the magnitude of the electric fields generated between the electrodes can be made to vary in multiple ways when applying an optional filter voltage Vf across the filter electrodes 21 and 22. Applying the detection cell 20 having such filter electrodes 21 and 22 to FAIMS analysis enables the scanning region of voltage applied to the filter electrodes 21 and 22 to be reduced to ½ for example, and by extension, to an inverse multiple of the number of regions.

The detection cell 20 may include the first substrate 23 and the second substrate 24 that are disposed separated from each other and opposing each other. The first substrate 23 includes the first portion 23A that is provided following the flow direction, and that supports the first region 21A and the first deflection electrode 26A (first downstream-side electrode) of the differently-shaped electrode 21, and the second portion 23B that is adjacent to the first portion in the intersecting direction and protrudes so that the distance of separation as to the second substrate 24 is smaller than that of the first portion, and that supports the second region 21B of the differently-shaped electrode 21 and the second deflection electrode 26B. According to the substrates 23 and 24 having such a configuration, the filter electrodes 21 and 22 can be stably supported in the detection cell 20. This is also suitable with regard to fabrication of the differently-shaped electrode 21, with respect to the point that the differently-shaped electrode 21 having a complicated shape can be accurately and conveniently fabricated, due to forming the electrode on the first substrate 23 by bottom-up formation of films or layers.

The detection cell 20 may include the wiring portions 21Y and 22Y (example of pair of major wiring lines) for supplying electric power to each of the filter electrodes 21 and 22, and the wiring portions 21Y and 22Y may each be connected to the end portions of the filter electrodes 21 and 22 in the intersecting direction. According to such a configuration, the wiring portions 21Y and 22Y can be kept from intersecting the flow of the object of measurement. As a result, a situation in which electric fields formed by the wiring portions 21Y and 22Y affects the flow of the object of measurement can be reduced, and reduction in analysis precision can be suppressed. Note that a configuration is conceivable in which the filter electrodes 21 and 22 and the wiring portions 21Y and 22Y are formed as a multilayered structure with an insulating layer interposed therebetween, so that the filter electrodes 21 and 22, and the wiring portions 21Y and 22Y are superimposed in a thickness direction (i.e., in the direction intersecting the flow direction and the intersecting direction). There is concern of short-circuiting in this configuration, since a high potential difference is generated at superimposed portions of the filter electrodes 21 and 22, and the wiring portions 21Y and 22Y. Accordingly, the above configuration is desirable in that such a superimposed multilayer structure does not have to be employed.

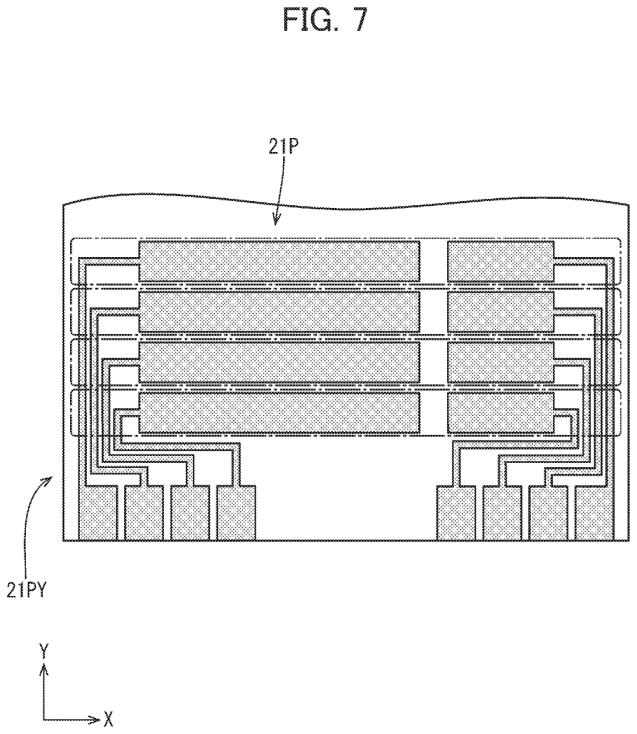

Now, for reference, in an arrangement in a FAIMS device including a detection cell having a plurality of filter electrodes 21P such as illustrated in FIG. 7, applying a plurality of different distributed voltages VC to the plurality of filter electrodes 21P at the same time is conceivable. In such a FAIMS device, in order to apply distributed voltages of a plurality of conditions to the filter electrodes at the same time, wiring to each filter electrode has to be performed, and the wiring circuit becomes complicated. Also, the distributed voltage applied in the FAIMS device is radio-frequency high voltage, and heat is generated due to frequent switching, and accordingly a complicated circuit configuration makes reduction in size even more difficult. Also, routed wiring to each filter electrode that is not superimposed on filter electrodes has to cut across channels of filters of other distributed voltage conditions, thereby affecting analysis precision. Accordingly, the detection cell 20 according to the present technology is suitable in that such trouble can be avoided.

In the above detection cell 20, the differently-shaped electrode 21 (one filter electrode) may include the third region 21C that is disposed arrayed with the first region 21A and the second region 21B with respect to the intersecting direction, and that protrudes so that the distance of separation as to the planar electrode 22 is smaller. The distance of separation from the planar electrode 22 (other filter electrode) may be determined for the first region 21A, the second region 21B, and the third region 21C, such that the difference ΔE₁₂ in magnitudes of electric fields formed in each of the first region 21A and the second region 21B, and the difference ΔE₂₃ in magnitudes of electric fields formed in each of the second region 21B and the third region 21C, are equal. According to this configuration, the magnitude of electric field generated between the pair of filter electrodes 21 and 22 when one optional filter voltage Vf is applied across the electrodes can be made to vary with equal differences. Accordingly, the resolution of the FAIMS spectrum can be raised uniformly.

The above FAIMS device 1 includes the detection cell 20, and the first potential adjusting unit 41 that controls the distributed voltage applied across at least one pair of the filter electrodes 21 and 22. The FAIMS device 1 may further include the second potential adjusting unit 42 that controls compensation voltage applied across the pair of filter electrodes 21 and 22. In the first embodiment, the first potential adjusting unit 41 applies distributed voltage to the planar electrode 22, and the second potential adjusting unit 42 applies compensation voltage to the differently-shaped electrode 21. According to such a configuration, the number of conditions of compensation voltage by the second potential adjusting unit 42 can be reduced to ½ or lower (an inverse multiple of “number of regions minus 1”). Thus, FAIMS analysis can be carried out with reduced time taken for measurement, while maintaining analysis precision. Alternatively, the number of measurement points can be increased and FAIMS analysis can be performed with higher precision within the same measurement time.

The FAIMS device 1 includes the storage unit M that stores one or a plurality of programs configured to be executed by the first potential adjusting unit 41 and the second potential adjusting unit 42. The one or the plurality of programs include instructions of applying, by the first potential adjusting unit 41, asymmetric alternating current voltage of a first magnitude across the pair of filter electrodes 21 and 22, and applying, by the second potential adjusting unit 42, direct current voltage across the pair of filter electrodes 21 and 22 while changing the magnitude thereof, during application of the asymmetric alternating current voltage of the first magnitude across the pair of filter electrodes 21 and 22. The magnitude of the direct current voltage applied by the second potential adjusting unit 42 is changed within a range in which the magnitude of the electric field formed in the first region 21A by the asymmetric alternating current voltage of the first magnitude, and the magnitude of the electric field formed in the second region 21B, are not duplicative. According to such a program, the magnitude of compensation voltage applied by the second potential adjusting unit 42 is changed (scanned) within a smaller range than the electric field generated in the second region 21B to generate a higher electric field, for example, and accordingly measurement time can be reduced. Also, reduced measurement time and improved analysis precision can both be realized at an even higher level.

In the FAIMS device 1, the one or the plurality of programs include instructions of applying, by the first potential adjusting unit 41, asymmetric alternating current voltage of a first magnitude and a second magnitude across the pair of filter electrodes 21 and 22, and applying, by the second potential adjusting unit 42, direct current voltage across the pair of filter electrodes 21 and 22 while changing the magnitude thereof during application of the asymmetric alternating current voltage of the first magnitude or the second magnitude across the pair of filter electrodes 21 and 22. The magnitude of the direct current voltage applied by the second potential adjusting unit 42 is changed within a range in which the magnitude of the electric field formed in the first region 21A by the asymmetric alternating current voltage of the first magnitude and the second magnitude, and the magnitude of the electric field formed in the each of the second to fourth regions 21B to 21D, are not duplicative. In other words, according to such a program, analysis under duplicative conditions can be avoided. Accordingly, at least one of reduced measurement time and improved analysis precision can be realized at an even higher level, for example.

### Embodiment 2

A FAIMS device 101 according to Embodiment 2 will be described with reference to FIG. 12. In Embodiment 2, the filter electrodes 21 and 22 are sealed at both ends in the intersecting direction by the spacers 28. In addition, the filter electrodes 21 and 22 may be connected in the proximity of the boundaries of adjacent regions 21A to 21D, by sealing members 128 that extend in the flow direction. Other configurations are the same as in Embodiment 1, and accordingly description of configurations, operations, and effects that are the same will be omitted.

The distance of separation between the filter electrodes 21 and 22 is adjusted by the spacers 28, and accordingly it is sufficient for the sealing members 128 to be able to partition the filer space. In other words, the spacers 28 contain spacer particles with high rigidity, but the sealing members 128 do not have to include spacer particles, and may be made up of a material having elasticity, for example. Suitable examples of materials making up such sealing members 128 include various types of synthetic resin materials and elastomer materials. The sealing members 128 may be provided between the filter electrodes 21 and 22, at the boundaries of the regions 21A to 21D, in the regions of which the distance of separation is smaller, as illustrated in FIG. 12. Also, the sealing members 128 may be provided between the filter electrodes 21 and 22 in the regions of which the distance of separation is greater, although this is not illustrated in detail.

### Modification

A FAIMS device 201 according to a modification of Embodiment 2 will be described with reference to FIG. 13. Sealing members 128A differ from Embodiment 2 with respect to the point of being provided straddling both regions at the boundaries of the regions 21A to 21D, as illustrated in FIG. 13. Other points are the same as Embodiment 2 above. In this case, an inner surface of the channel is smooth, which is desirable since the possibility of the flow of the object of measurement being disturbed is reduced. Also, although not illustrated in detail, the boundaries of the regions 21A to 21D may be tapered, rather than forming angular steps as illustrated in FIG. 13. In this case, the adhesion between the sealing members and the filter electrodes 21 and 22 is improved, which is desirable.

### Embodiment 3

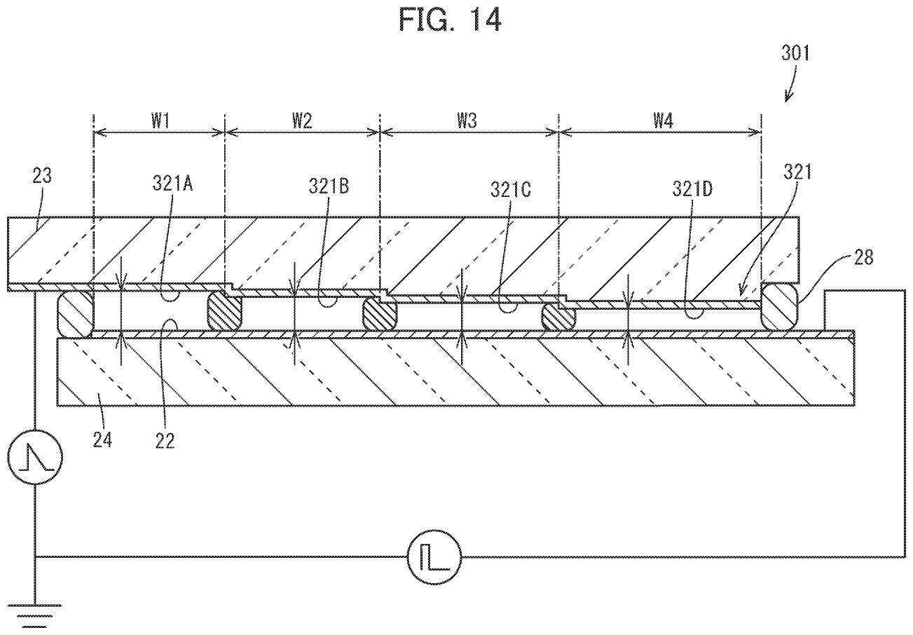

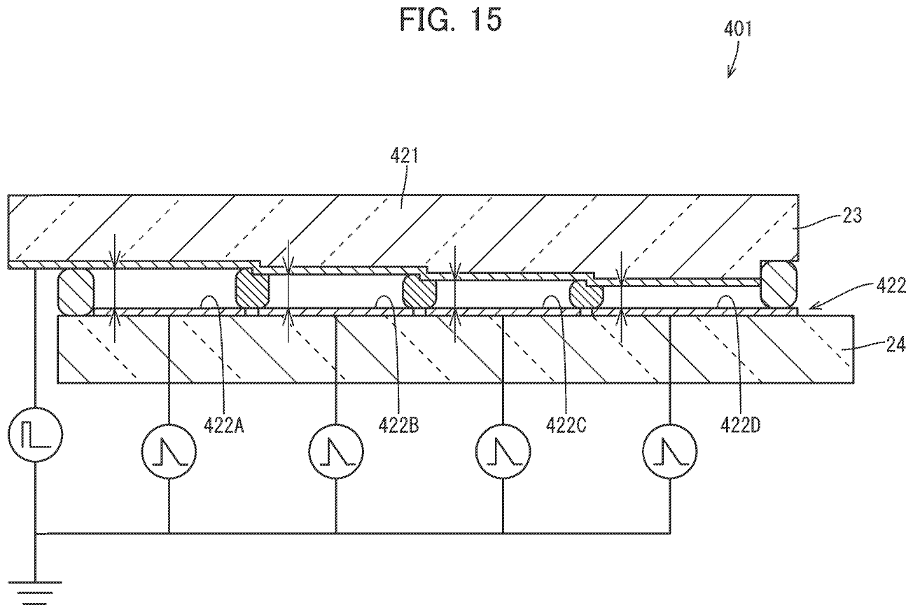

A FAIMS device 301 according to Embodiment 3 will be described with reference to FIG. 14. In a differently-shaped electrode 321 according to Embodiment 3, a dimension of a second region 321B in the intersecting direction may be longer than a dimension of a first region 321A in the intersecting direction. Also, dimensions W1 to W4 of regions S321A to 321D in the intersecting direction have a relation of W1<W2<W3<W4. Other configurations are the same as in Embodiments 1 and 2, and accordingly description of configurations, operations, and effects that are the same will be omitted.

According to such a configuration, an area of the second region 321B, of which the distance between the filter electrodes 321 and 22 is smaller than that of the first region 321A, can be increased. In other words, the difference between a channel cross-sectional area with respect to the electric field formed between the first region 321A and the planar electrode 22 and the channel cross-sectional area with respect to the electric field formed between the second region 321B and the planar electrode 22 can be reduced. For example, the cross-sectional areas of the channels can be made to be equal. Accordingly, the amount of specimen passing through each channel can be made uniform, which can simplify analysis of the measurement results, for example. In particular, according to such a configuration, application to a detection cell 320 of a configuration in which the sealing members 128 partition between the pair of filter electrodes is desirable, since the effects thereof become more pronounced.

### Embodiment 4

A FAIMS device 401 according to Embodiment 4 will be described with reference to FIG. 15. In the FAIMS device 401 according to Embodiment 4, a planar electrode 422 is divided into regions corresponding to each of regions 421A to 421D of a differently-shaped electrode 421. That is to say, the planar electrode 422 includes a first planar electrode 422A, a second planar electrode 422B, a third planar electrode 422C, and a fourth planar electrode 422D. These first through fourth planar electrodes 422A to 422D each have rectangular shapes that are long in the flow direction, and are separated from each other. Also, the first potential adjusting unit 41 applies distributed voltage to the differently-shaped electrode 421, and the second potential adjusting unit 42 applies compensation voltage to each of the first through fourth planar electrodes 422A to 422D. Other configurations are the same as in Embodiments 1 or 2, and accordingly description of configurations, operations, and effects that are the same will be omitted.

In the above configuration, the second potential adjusting unit 42 is configured to adjust the compensation voltage applied to each of the first through fourth planar electrodes 422A to 422D, taking into consideration the distances of separation g1 to g4 between the differently-shaped electrode 421 and the first through fourth planar electrodes 422A to 422D, so that equal compensation electric fields are formed between the first through fourth planar electrodes 422A to 422D and the differently-shaped electrode 421. According to such a configuration, when the first potential adjusting unit 41 applies a distributed voltage VD of a predetermined magnitude between the filter electrodes 421 and 422, the electric field formed between the filter electrodes 421 and 422 by this distributed voltage VD can be made to vary. In other words, the number of conditions of distributed voltage by the first potential adjusting unit 41 can be reduced to ½ or lower (an inverse multiple of “number of regions minus 1”). Thus, FAIMS analysis can be carried out with reduced time taken for measurement, while maintaining analysis precision by such a configuration as well. Alternatively, the number of measurement points can be increased and FAIMS analysis can be performed with higher precision within the same measurement time.

### Other Embodiments

The technology disclosed herein is not limited to the embodiments described by way of the above description and the drawings. For example, the following embodiments are also encompassed by the technical scope.

(1) In the above embodiments, the differently-shaped electrode 21 includes four regions extending in the flow direction, and has three steps. However, the number of regions that the differently-shaped electrode 21 includes is not limited to this, and may be two or more (e.g., two, three, five, or more).

(2) In the above embodiments, the four regions that the differently-shaped electrode 21 includes, namely, the first region 21A, the second region 21B, the third region 21C, and the fourth region 21D, are arrayed in this order with respect to the intersecting direction. However, the order of array of the first region 21A, the second region 21B, the third region 21C, and the fourth region 21D, is not limited to this. For example, the first region 21A of which the distance of separation from the planar electrode 22 is greatest may be positioned at the center, and the remaining regions may be distributed on both sides thereof in order. For example, the regions may be distributed in the order of the third region 21C, the first region 21A, the second region 21B, and the fourth region 21D, with respect to the intersecting direction. The combination of other regions distributed on both sides of the first region 21A is not limited. Also, one or a plurality of regions may be divided into two portions and distributed, such as in the order of the fourth region 21D, the third region 21C, the second region 21B, the first region 21A, the second region 21B, the third region 21C, and the fourth region 21D, with respect to the intersecting direction.

(3) In the above embodiments, the detection electrode and the deflection electrode may be on either of the downstream side of the differently-shaped electrode (one filter electrode) and the downstream side of the planar electrode (other filter electrode). Also, in the above embodiments, a plurality of deflection electrodes are provided, paired with a plurality of detection electrodes. However, the deflection electrode may be a single deflection electrode in which a plurality of the deflection electrode are continuous. Each of the deflection electrodes is provided as a plurality, paired with the plurality of detection electrodes.

(4) In the above embodiments, an ArF excimer laser is used as the exposing light source in the ultrafine processing technology (lithography technology) for fabricating the electrodes. The exposing light source is not limited to this example, and may be another exposing light source, such as a krypton fluoride (KrF) excimer laser, ultraviolet light, extreme ultraviolet light (EUV), radiant light (typically X-rays), radiant rays (typically electron beams), ion beams, or the like, for example.

(5) In the above embodiments, the first base member and the second base member are both plate-like. However, other shapes of the first base member and the second base member, such as the shapes of the rear face and so forth, are not limited in particular, as long as the supporting faces for the electrodes have particular face shapes (stepped or flat).

(6) In the above embodiments, the spacers are made up of a sealing material that is dry-cured. However, the spacer configuration is not limited to this example, and double-sided adhesive tape, synthetic resin members, and so forth, having a predetermined thickness, may be used, for example. Also, the detection cell 20 is desirably obtained by, for example, forming a plurality of electrode layers in arrays on each of a first substrate 23 and a second substrate 24 having a larger diameter than a single detection cell 20, bonding to the first substrate 23 and the second substrate 24 to each other, and thereafter cutting into individual detection cells 20. The cutting may be performed by contact processing using a dicing cutter, or may be performed by non-contact processing using a laser. Cutting of the first substrate 23 and the second substrate 24 may be performed before bonding of the first substrate 23 and the second substrate 24, or may be performed after bonding thereof.

The present disclosure contains subject matter related to that disclosed in Japanese Priority Patent Application JP 2021-210060 filed in the Japan Patent Office on Dec. 24, 2021, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A detection cell, comprising:
a pair of filter electrodes;
a first downstream-side electrode;
a second downstream-side electrode;
a first opposing electrode; and
a second opposing electrode, wherein
the filter electrodes are disposed separated from each other and opposing each other,
one of the pair of filter electrodes includes
a first region that is provided following a flow direction of an object of measurement introduced between the pair of filter electrodes, and
a second region that is provided arrayed with the first region with respect to an intersecting direction intersecting the flow direction, and that protrudes to a position at which a distance of separation as to an other of the pair of filter electrodes is smaller than that of the first region,
the first downstream-side electrode and the second downstream-side electrode are respectively disposed on a downstream side of the first region and the second region, in the flow direction, and are separated from each other with respect to the intersecting direction, and
the first opposing electrode and the second opposing electrode are disposed on the downstream side from the other of the pair of filter electrodes, and oppose the first downstream-side electrode and the second downstream-side electrode.

2. The detection cell according to claim 1, further comprising:
a first base member and a second base member that are disposed separated from each other and opposing each other, wherein
the first base member includes
a first portion that is provided following the flow direction, and that supports the first region and the first downstream-side electrode of the one filter electrode, and
a second portion that is adjacent to the first portion in the intersecting direction and protrudes to a position at which a distance of separation as to the second base member is smaller than that of the first portion, and that supports the second region of the one filter electrode and the second downstream-side electrode, and
the second base member includes the other filter electrode, and the first opposing electrode and the second opposing electrode.

3. The detection cell according to claim 1, wherein the pair of filter electrodes are connected by a sealing member that extends in the flow direction at each of both ends thereof in the intersecting direction, and in a proximity of boundaries of the first region and the second region.

4. The detection cell according to claim 1, wherein a tapered portion is provided between the first region and the second region of the one filter electrode.

5. The detection cell according to claim 1, further comprising:
a pair of major wiring lines for supplying electric power to each of the pair of filter electrodes, wherein
the pair of major wiring lines are respectively connected to the pair of filter electrodes at end portions of the filter electrodes in the intersecting direction thereof.

6. The detection cell according to claim 1, wherein a dimension of the second region in the intersecting direction is longer than a dimension of the first region in the intersecting direction.

7. The detection cell according to claim 1, wherein
the one filter electrode includes a third region that is disposed arrayed with the first region and the second region with respect to the intersecting direction, and that protrudes to a position at which a distance of separation as to the other filter electrode is smaller than that of the first region and the second region, and
a distance of separation from the other filter electrode is determined for the first region, the second region, and the third region, with a difference in magnitudes of electric fields formed in each of the first region and the second region, and a difference in magnitudes of electric fields formed in each of the second region and the third region, being equal.

8. A FAIMS device, comprising:
the detection cell according to claim 1; and
a first control unit that controls at least distributed voltage applied across the pair of filter electrodes.

9. The FAIMS device according to claim 8, further comprising:
a second control unit that controls compensation voltage applied across the pair of filter electrodes.

10. The FAIMS device according to claim 9, further comprising:
a storage unit storing one or a plurality of programs configured to be executed by the first control unit and the second control unit, the one or the plurality of programs including instructions of:
applying, by the first control unit, asymmetric alternating current voltage of a first magnitude across the pair of filter electrodes; and
applying, by the second control unit, direct current voltage across the pair of filter electrodes while changing a magnitude thereof, during application of the asymmetric alternating current voltage of the first magnitude across the pair of filter electrodes, wherein
the magnitude of the direct current voltage applied by the second control unit is changed within a range in which a magnitude of an electric field formed in the first region by the asymmetric alternating current voltage of the first magnitude, and a magnitude of an electric field formed in the second region, are not duplicative.

11. The FAIMS device according to claim 9, wherein the one or plurality of programs include instructions of:
applying, by the first control unit, asymmetric alternating current voltage of a first magnitude and a second magnitude across the pair of filter electrodes; and
applying, by the second control unit, direct current voltage across the pair of filter electrodes while changing a magnitude thereof, during application of the asymmetric alternating current voltage of the first magnitude or the second magnitude across the pair of filter electrodes, and
the magnitude of the direct current voltage applied by the second control unit is changed within a range in which a magnitude of an electric field formed in the first region by the asymmetric alternating current voltage of the first magnitude and the second magnitude, and a magnitude of an electric field formed in the second region, are not duplicative.

12. A program being for operating the FAIMS device according to claim 10, the program including instructions of:
applying, by the first control unit, asymmetric alternating current voltage of a first magnitude across the pair of filter electrodes; and
applying, by the second control unit, direct current voltage across the pair of filter electrodes while changing a magnitude thereof, during application of the asymmetric alternating current voltage of the first magnitude across the pair of filter electrodes, wherein
the magnitude of the direct current voltage applied by the second control unit is changed within a range in which a magnitude of an electric field formed in the first region by the asymmetric alternating current voltage of the first magnitude, and a magnitude of an electric field formed in the second region, are not duplicative.

13. A program being for operating the FAIMS device according to claim 11, the program including instructions of:
applying, by the first control unit, asymmetric alternating current voltage of a first magnitude and a second magnitude across the pair of filter electrodes; and
applying, by the second control unit, direct current voltage across the pair of filter electrodes while changing a magnitude thereof, during application of the asymmetric alternating current voltage of the first magnitude or the second magnitude across the pair of filter electrodes, wherein
the magnitude of the direct current voltage applied by the second control unit is changed within a range in which a magnitude of an electric field formed in the first region by the asymmetric alternating current voltage of the first magnitude and the second magnitude, and a magnitude of an electric field formed in the second region, are not duplicative.
